(19) United States
(12) Patent Application Publication
(10) Pub. No.: US 2007/0143921 A1
(43) Pub. Date: Jun. 28, 2007

(54) Bed apparatus and MRI apparatus

(75) Inventor: Yoichi Hiyama, Sakura-Shi (JP)

Correspondence Address: NIXON & VANDERHYE, PC, 901 NORTH GLEBE ROAD, 11TH FLOOR, ARLINGTON, VA, 22203, US

(73) Assignees: KABUSHIKI KAISHA TOSHIBA, Tokyo (JP); TOSHIBA MEDICAL SYSTEMS CORPORATION, Otawara-Shi (JP)

(21) Appl. No.: 11/645,620

(22) Filed: Dec. 27, 2006

(30) Foreign Application Priority Data
Dec. 27, 2005 (JP) 376259/2005

(51) Int. Cl. A61G 13/06; A61G 13/00

(52) U.S. Cl. 5/601; 5/943; 384/611

(57) ABSTRACT

A bed apparatus has a table-top movable at least in a longitudinal direction, a bed supporting unit located below the table-top, an intermediate unit located at a position between the table-top and the bed supporting unit and not overlapping with a center in a width direction of the table-top, and movable in the same direction as the table-top, and a changing unit configured to change a relative positional relationship of the table-top and the intermediate unit while the intermediate unit moves with respect to the bed supporting unit.

### BACKGROUND OF THE INVENTION

1. Field of the Invention

The present invention relates to a bed apparatus and a magnetic resonance imaging (MRI) apparatus for use in a diagnostic imaging apparatus.

2. Description of the Related Art

A diagnostic imaging apparatus for performing diagnostic imaging by imaging an object includes an MRI apparatus, an X-ray computed tomography (CT) apparatus, a positron emission tomography (PET) apparatus, an X-ray diagnostic apparatus, and the like.

The diagnostic imaging apparatus, such as the MRI apparatus, the X-ray CT apparatus, the PET apparatus, and the like, includes a stage unit formed with an opening for performing the imaging. The imaging is performed with the object inserted in the opening part. Further, an X-ray diagnostic apparatus for the circulatory system includes an imaging unit provided with an X-ray generation unit and an X-ray detection unit, which are held at a C-shaped end portion thereof to face each other. The imaging is performed with the object inserted in a space (in the opening part) formed between the X-ray generation unit and the X-ray detection unit. The insertion of the object into the opening part is performed by mounting the object on a table-top of a bed apparatus located in the vicinity of the opening part and then moving the table-top into the opening part.

For the imaging performed by using the MRI apparatus, the bed apparatus has been known which is provided with a mechanical unit for moving the table-top to set the table-top at a position in the opening part apart from the bed apparatus.

There is another bed apparatus provided with two table-tops of an upper table-top and a lower table-top for the imaging of the entirety or a wide area including almost the entirety of the object. The object is mounted on the upper table-top of the bed apparatus, and the two table-tops of the upper table-top and the lower table-top are horizontally moved in a longitudinal direction of the table-tops, with the two table-tops aligned with each other. Thereby, the object is set at an imaging position. If the object cannot be set at a desired position, the upper table-top is further pushed in by hand to set the object at the desired position.

In the bed apparatus including the mechanical unit for moving the table-top, however, it is impossible to set the table-top by moving the table-top by a distance longer than the distance of the table-top excluding a portion thereof attached with the mechanical unit. To image the entirety of the object, therefore, the table-top needs to have a length including an entire length of the object and the length of the part of the table-top attached with the mechanical unit. As a result, there arises a problem of an increase in size of the bed apparatus.

Further, in the bed apparatus in which the two table-tops of the upper table-top and the lower table-top are stretched, the movement of the upper table-top is manually performed. Thus, the apparatus has a problem in that the moving operation is troublesome. If the upper table-top is also provided with a drive mechanism similar to the mechanism of the lower table-top, such as a cable, two mechanisms are required at two locations for the lower and upper table-top. As a result, there arises a problem of complication in configuration of the apparatus.

As well as the above apparatuses, Japanese Unexamined Patent Application Publication No. 2006-129938 discloses a bed apparatus which has an intermediate unit for supporting and driving to move a table-top, a bed body for supporting and moving the table-top and the intermediate unit, and a drive source for driving the table-top and the intermediate unit, and in which the drive source drives to move the table-top and the intermediate unit at the same time and at different speeds. According to an MRI apparatus including this bed apparatus, however, the intermediate unit is located below the table-top at the center position in a width direction of the table-top. Thus, signal cables for transmitting a received signal and a control signal are provided at the opposite sides of the intermediate unit. In this case, there arises a problem of an increase in size of a whole body (WB) coil for transmission. Further, electrical wiring and the like cannot be located below the table-top at the center position in the width direction of the table-top also in such diagnostic imaging apparatuses as the X-ray CT apparatus and the PET apparatus.

### SUMMARY OF THE INVENTION

The present invention has taken into consideration the above-described problems, and it is an object of the present invention to provide a bed apparatus and an MRI apparatus, to prevent an increase in length in a longitudinal direction of a table-top, and thus to prevent an increase in size of the apparatus because the table-top is set at a position more apart from a bed supporting unit.

To solve the above-described problems, the present invention provides the bed apparatus to mention it in claim 1, comprising: a table-top movable at least in a longitudinal direction; a bed supporting unit located below the table-top; an intermediate unit located at a position between the table-top and the bed supporting unit and not overlapping with a center in a width direction of the table-top, and movable in the same direction as the table-top; and a changing unit configured to change a relative positional relationship of the table-top and the intermediate unit while the intermediate unit moves with respect to the bed supporting unit.

To solve the above-described problems, the present invention provides the bed apparatus to mention it in claim 9, comprising: a table-top movable at least in a longitudinal direction; a bed supporting unit located below the table-top; a first intermediate unit located at a position between the table-top and the bed supporting unit and not overlapping with a center in a width direction of the table-top, and movable in the same direction as the table-top; a second intermediate unit located at a position between the table-top and the first intermediate unit and not overlapping with the center in the width direction of the table-top, and movable in the same direction as the table-top; and a changing unit configured to change a relative positional relationship of the table-top, the first intermediate unit and the second intermediate unit while the first intermediate unit moves with respect to the bed supporting unit.

To solve the above-described problems, the present invention provides the bed apparatus to mention it in claim 10, comprising: a table-top movable at least in a longitudinal direction; a bed supporting unit located below the table-top; a plurality of intermediate units located at a position between the table-top and the bed supporting unit and not overlapping with a center in a width direction of the table-top, and movable in the same direction as the table-top; and a changing unit configured to change a relative positional relationship of the table-top and the plurality of intermediate units while one of the plurality of intermediate units moves with respect to the bed supporting unit.

To solve the above-described problems, the present invention provides the MRI apparatus to mention it in claim 11, comprising: a table-top movable at least in a longitudinal direction; a bed supporting unit located below the table-top; an intermediate unit located at a position between the table-top and the bed supporting unit and not overlapping with a center in a width direction of the table-top, and movable in the same direction as the table-top; and a changing unit configured to change a relative positional relationship of the table-top and the intermediate unit while the intermediate unit moves with respect to the bed supporting unit.

To solve the above-described problems, the present invention provides the MRI apparatus to mention it in claim 20, comprising: a table-top movable at least in a longitudinal direction; a bed supporting unit located below the table-top; a first intermediate unit located at a position between the table-top and the bed supporting unit and not overlapping with a center in a width direction of the table-top, and movable in the same direction as the table-top; a second intermediate unit located at a position between the table-top and the first intermediate unit and not overlapping with the center in the width direction of the table-top, and movable in the same direction as the table-top; and a changing unit configured to change a relative positional relationship of the table-top, the first intermediate unit and the second intermediate unit while the first intermediate unit moves with respect to the bed supporting unit.

To solve the above-described problems, the present invention provides the MRI apparatus to mention it in claim 21, comprising: a table-top movable at least in a longitudinal direction; a bed supporting unit located below the table-top; a plurality of intermediate units located at a position between the table-top and the bed supporting unit and not overlapping with a center in a width direction of the table-top, and movable in the same direction as the table-top; and a changing unit configured to change a relative positional relationship of the table-top and the plurality of intermediate units while one of the plurality of intermediate units moves with respect to the bed supporting unit.

Therefore, according to the present invention to provide the bed apparatus and MRI apparatus, while the intermediate unit with a simple structure moves in the longitudinal direction, the table-top can be moved in the same direction as the intermediate unit. Accordingly, it is possible to prevent an increase in length in the longitudinal direction of the table-top, and thus to prevent an increase in size of the apparatus because the table-top is set at a position more apart from the bed supporting unit than the intermediate unit is.

### BRIEF DESCRIPTION OF THE DRAWINGS

In the accompanying drawings:

FIG. 1 is a block diagram illustrating a configuration of an MRI apparatus (a bed apparatus) according to a first embodiment of the present invention;

FIG. 2 is a side view to describe an outline of the MRI apparatus according to the first embodiment;

FIG. 3 is an arrow view of the MRI apparatus according to the first embodiment cut along the III-III line;

FIG. 4 is a diagram illustrating a configuration example of an RF coil and an RF transmitting and receiving unit illustrated in FIG. 1;

FIG. 5 is a diagram illustrating a location example of surface coils provided on a body surface side of an object illustrated in FIG. 4;

FIG. 6 is a diagram illustrating a location example of the surface coils provided on a back surface side of the object illustrated in FIG. 4;

FIG. 7 is a diagram illustrating another location example of the surface coils provided on the body surface side of the object illustrated in FIG. 4;

FIG. 8 is a diagram illustrating another location example of the surface coils provided on the body surface side of the object illustrated in FIG. 4;

FIG. 9 is a side view illustrating a wiring example of a cable which transmits a received signal and a control signal between the RF coil and the RF transmitting and receiving unit illustrated in FIG. 1;

FIG. 10 is a diagram illustrating a detailed configuration of a table-top of the MRI apparatus according to the first embodiment;

FIG. 11 is a diagram illustrating a detailed configuration of the table-top of the MRI apparatus according to the first embodiment;

FIG. 12 is a diagram illustrating a detailed configuration of a middle frame of the MRI apparatus according to the first embodiment;

FIG. 13 is a diagram illustrating a detailed configuration of the middle frame of the MRI apparatus according to the first embodiment;

FIG. 14 is a diagram illustrating a detailed configuration of a horizontal moving mechanical unit of the MRI apparatus according to the first embodiment;

FIG. 15 is a diagram illustrating a detailed configuration of the horizontal moving mechanical unit of the MRI apparatus according to the first embodiment;

FIG. 16 is a configuration diagram illustrating an example of the horizontal moving mechanical unit, in which a bed unit is viewed from a front side;

FIG. 17 is a configuration diagram illustrating an example of the horizontal moving mechanical unit, in which the bed unit is viewed from the front side;

FIG. 18 is a diagram illustrating a detailed configuration of a vertical moving mechanical unit of the MRI apparatus according to the first embodiment;

FIG. 19 is a diagram illustrating an operation of the middle frame and the table-top of the MRI apparatus according to the first embodiment;

FIG. 20 is a diagram illustrating the operation of the middle frame and the table-top of the MRI apparatus according to the first embodiment;

FIG. 21 is a diagram for explaining an operation of the horizontal moving mechanical unit that makes the table-top move;

FIG. 22 is a diagram for explaining the operation of the horizontal moving mechanical unit that makes the table-top move;

FIG. 23 is a diagram for explaining a distance that the table-top of the MRI apparatus according to the second embodiment movable;

FIG. 24 is a block diagram illustrating a configuration of an MRI apparatus (a bed apparatus) according to a second embodiment of the present invention;

FIG. 25 is a diagram illustrating a detailed configuration of a table-top of the MRI apparatus according to the second embodiment;

FIG. 26 is a diagram illustrating a detailed configuration of the table-top of the MRI apparatus according to the second embodiment;

FIG. 27 is a diagram illustrating a detailed configuration of middle frames of the MRI apparatus according to the second embodiment;

FIG. 28 is a diagram illustrating a detailed configuration of the middle frames of the MRI apparatus according to the second embodiment;

FIG. 29 is a diagram illustrating a detailed configuration of a horizontal moving mechanical unit of the MRI apparatus according to the second embodiment;

FIG. 30 is a diagram illustrating a detailed configuration of the horizontal moving mechanical unit of the MRI apparatus according to the second embodiment;

FIG. 31 is a configuration diagram illustrating an example of the horizontal moving mechanical unit, in which a bed unit is viewed from a front side;

FIG. 32 is a diagram illustrating an operation of the middle frame and the table-top of the MRI apparatus according to the second embodiment;

FIG. 33 is a diagram illustrating the operation of the middle frame and the table-top of the MRI apparatus according to the second embodiment;

FIG. 34 is a diagram for explaining an operation of the horizontal moving mechanical unit that makes the table-top move; and

FIG. 35 is a diagram for explaining the operation of the horizontal moving mechanical unit that makes the table-top move.

### DESCRIPTION OF THE PREFERRED EMBODIMENTS

As a diagnostic imaging apparatus provided with a gantry having an imaging unit for forming an image, the present invention can be used in an X-ray computed tomography (CT) apparatus, a magnetic resonance imaging (MRI) apparatus, a positron emission tomography (PET) apparatus, an X-ray diagnostic imaging apparatus, and the like, for example. Description will now be made on a case in which the present invention is used in the MRI apparatus.

### First Embodiment

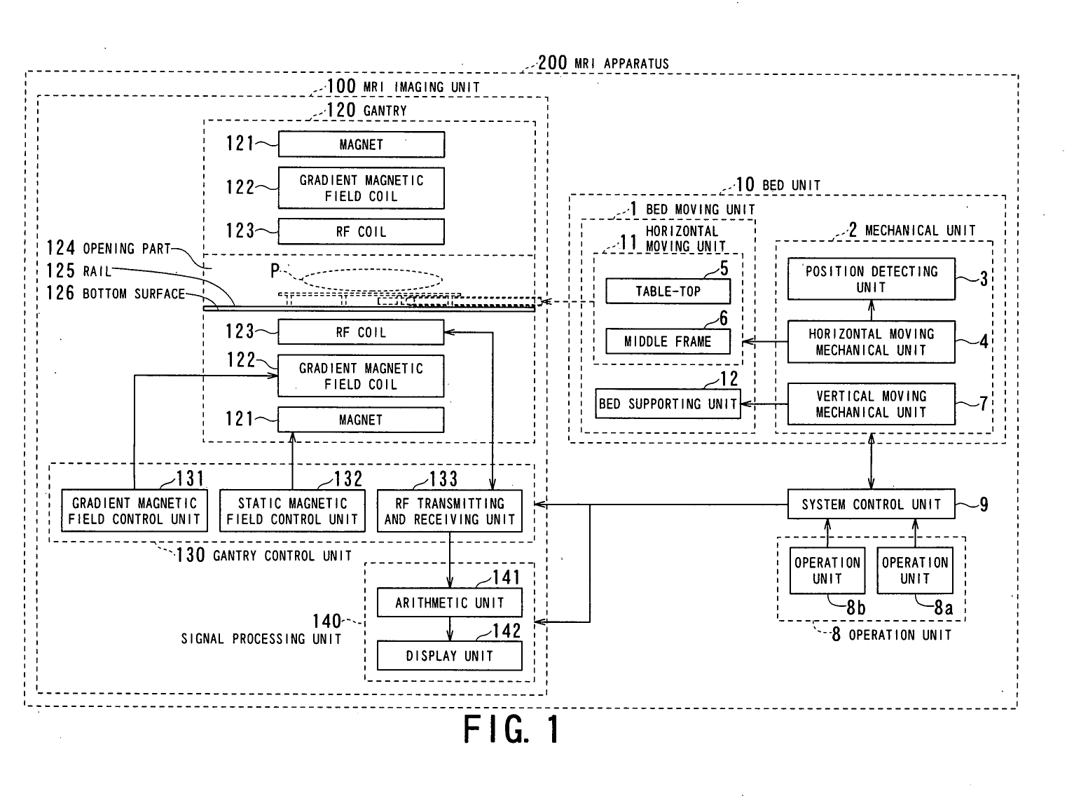

Description will be made below on a first embodiment of an MRI apparatus according to the present invention with reference to FIGS. 1 to 23. FIG. 1 is a block diagram illustrating a configuration of the MRI apparatus (a bed apparatus) according to the first embodiment of the present invention.

FIG. 1 illustrates an MRI apparatus 200 according to the first embodiment of the present invention. The MRI apparatus 200 has an MRI imaging unit 100 for performing MRI imaging of a object P, a bed unit 10 for setting the object P at an imaging position in the MRI imaging unit 100, an operation unit 8 for operating the MRI imaging unit 100 and the bed unit 10, and a system control unit 9 for controlling the MRI imaging unit 100 and the bed unit 10 on the basis of a signal sent by the operation unit 8.

The MRI imaging unit 100 has a gantry 120 for generating a magnetic field around the object P, a gantry control unit 130 for controlling the magnetic field inside the gantry 120, and a signal processing unit 140 for processing a signal output from the gantry 120 and generating and displaying image data.

The gantry 120 is formed with an opening part 124 for performing the imaging of the object P. A bottom surface 126 of the opening part 124 is provided with rails 125 for guiding a part of the bed unit 10. Inside the gantry 120, there are provided a magnet 121 for generating a static magnetic field, a gradient magnetic field coil 122 for generating a gradient magnetic field to add positional information to the static magnetic field, and a radio frequency (RF) coil 123 for transmitting and receiving a high frequency signal.

The magnet 121 is held to the inner circumference of the gantry 120, and generates a static magnetic field around the object P set in the opening part 124 in accordance with a super conducting method, for example. In this process, a static magnetic field power supply (not illustrated) of the magnet 121 is controlled by the gantry control unit 130.

The gradient magnetic field coil 122 is held on the inner circumference of the magnet 121, and generates the gradient magnetic field around the object P set in the opening part 124. In this process, a gradient magnetic field power supply (not illustrated) of the gradient magnetic field coil 122 is controlled by the gantry control unit 130.

The RF coil 123, which is held between the gradient magnetic field coil 122 and the object P, applies a high frequency magnetic field to the object P for exciting hydrogen nuclei present inside the object P, receives a nuclear magnetic resonance signal emitted from the object P, and outputs the received signal to the gantry control unit 130.

The gantry control unit 130 has a gradient magnetic field control unit 131, a static magnetic field control unit 132, and an RF transmitting and receiving unit 133. The gradient magnetic field control unit 131 controls the gradient magnetic field which supplies to the gradient magnetic field coil 122. The static magnetic field control unit 132 controls the static magnetic field which supplies to the magnet 121.

Further, the RF transmitting and receiving unit 133 has a transmitter circuit for transmitting a high frequency to the RF coil 123, a receiver circuit for receiving and processing the signal output from the RF coil 123, and an RF sequencer for controlling the transmitter circuit and the receiver circuit. The RF transmitting and receiving unit 133 sends the signal output from the receiver circuit to the signal processing unit 140.

The signal processing unit 140 has an arithmetic unit 141 and a display unit 142. The arithmetic unit 141 performs image processing on the signal sent from the RF transmitting and receiving unit 133 of the gantry control unit 130 to generate image data. The generated image data is displayed on the display unit 142, such as a cathode ray tube (CRT).

The bed unit 10 has a bed moving unit 1 on which the object P is mounted, and a mechanical unit 2 for moving the bed moving unit 1 in horizontal and vertical directions to set the object P in the opening part 124 of the gantry 120 in the MRI imaging unit 100.

The bed moving unit 1 has a horizontal moving unit 11 and a bed supporting unit 12 for supporting the horizontal moving unit 11. Further, the horizontal moving unit 11 has a table-tops on which the object P is mounted, and an intermediate unit (a middle frame) 6 located between the table-top 5 and the bed supporting unit 12 for moving the table-top 5 into the opening part 124 of the MRI imaging unit 100.

The mechanical unit 2 has a horizontal moving mechanical unit 4 for horizontally moving the horizontal moving unit 11, a position detecting unit 3 for detecting the position of the horizontal moving unit 11, and a vertical moving mechanical unit 7 for vertically moving the bed moving unit 1.

The operation unit 8 has an input device, such as a keyboard, and a display panel, which are not illustrated. The operation unit 8 has operation sections 8a and 8b. The operation section 8a performs the operation of the MRI imaging unit 100 through, for example, input of imaging conditions for performing the MRI imaging, and the operation of the bed unit 10 through, for example, input for setting the object P mounted on the table-top 5 in the opening part 124 of the gantry 120. The operation section 8b performs solely the operation of the bed unit 10. The operation section 8b is located to the gantry 120 so that the operation section 8b can be operated near the object P when the object P mounted on the table-top 5 of the bed unit 10 is moved into the opening part 124 of the gantry 120.

The system control unit 9 has a central processing unit (CPU), a memory circuit, and the like, which are not illustrated. On the basis of a signal input from the operation unit 8, the system control unit 9 performs a control of the entire system including a control relating to the MRI imaging on the gantry control unit 130 and the signal processing unit 140 of the MRI imaging unit 100, and a control relating to the moving operation of the mechanical unit 2 of the bed unit 10.

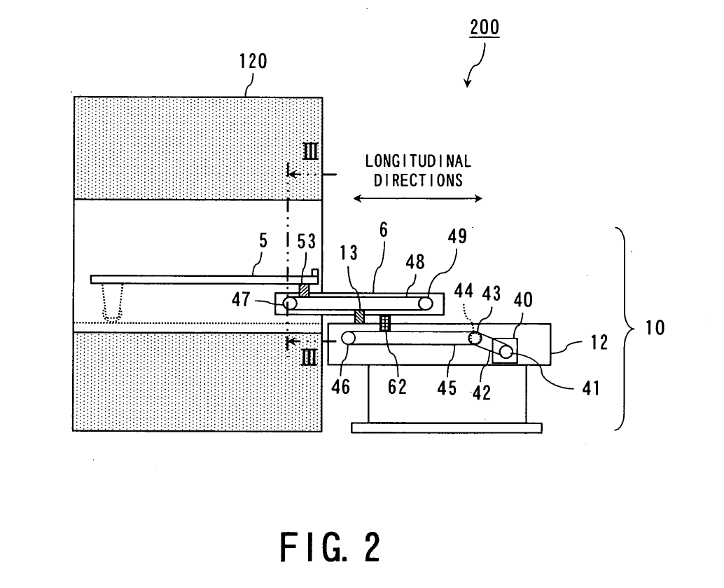

FIG. 2 is a side view of the MRI apparatus 200. For the sake of convenience, relative sizes of components are changed in the MRI apparatus 200 illustrated in FIG. 2 to make the explanation of the respective components easy.

FIG. 2 illustrates the gantry 120 and the bed unit 10 of the MRI apparatus 200. The bed unit 10 has the table-top 5 which moves at least in the longitudinal direction (i.e., the lateral directions in FIG. 2), the bed supporting unit 12 located below the table-top 5, and the middle frame 6 which is located between the table-top 5 and the bed supporting unit 12 and moves in the longitudinal direction. The bed unit 10 changes the relative positional relationship between the table-top 5 and the middle frame 6 while the middle frame 6 moves with respect to the bed supporting unit 12. The table-top 5 is configured to have a longer length in the longitudinal direction than the length in the longitudinal direction of the middle frame 6.

The bed supporting unit 12 holds a first moving mechanism and a drive mechanism for operating the first moving mechanism, and the middle frame 6 connected to the first moving mechanism holds a second moving mechanism connected to the table-top 5. As the drive mechanism drives to operate the first moving mechanism, the middle frame 6 is moved, and the second moving mechanism is operated. Thereby, the table-top 5 is moved in the same direction as the middle frame 6.

For example, the bed supporting unit 12 has, as the drive mechanism, a motor 40, a drive pulley 41 rotated by the drive of the motor 40, an input pulley 43, and a belt 42 rotated with the drive pulley 41 and the input pulley 43 disposed at the opposite ends thereof. The bed supporting unit 12 further has, as the first moving mechanism, an output pulley 44 rotated in conjunction with the rotation of the input pulley 43, an idle pulley 46, and a belt 45 rotated with the output pulley 44 and the idle pulley 46 disposed at the opposite ends thereof. Further, the middle frame 6 connected to the fist moving mechanism has, as the second moving mechanism, idle pulleys 47 and 49 and a belt 48 rotated with idle pulleys 47 and 49 disposed at the opposite ends thereof.

As the motor 40 is driven, the drive pulley 41, the belt 42, and the input pulley 43 are operated, and the output pulley 44 is rotated. In accordance with the rotation of the output pulley 44, the belt 45 is rotated around the output pulley 44 and the idle pulley 46. Then, in accordance with the rotation of the belt 45, an intermediate unit connecting portion 62, which serves as a connecting portion for connecting a part of the belt 45 to a part of the middle frame 6, is moved in the longitudinal direction. In accordance with the movement of the intermediate unit connecting portion 62, the middle frame 6 is moved in the same direction as the intermediate unit connecting portion 62. Then, in accordance with the movement of the middle frame 6, the belt 48 held by the middle frame 6 is rotated around the idle pulleys 47 and 49. In accordance with the rotation of the belt 48, a table-top connecting portion 53, which serves as a connecting portion for connecting a part of the belt 48 to a part of the table-top 5, is moved in the same direction as the middle frame 6. Then, in accordance with the movement of the table-top connecting portion 53, the table-top 5 is moved in the same direction as the table-top connecting portion 53. A part of the belt 48 is connected to a part of the bed supporting unit 12 by a bed supporting unit connecting portion 13.

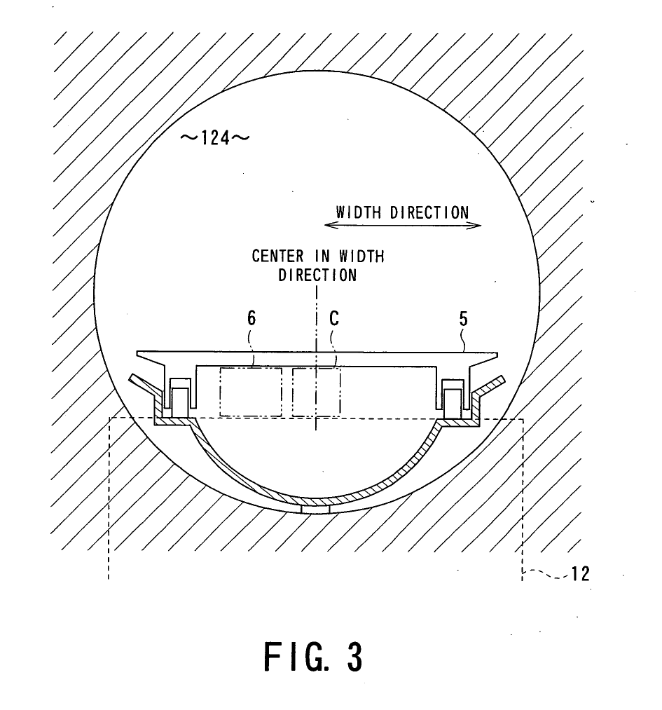

FIG. 3 is an arrow view of the MRI apparatus 200 cut along the III-III line, i.e., an arrow view of the side view illustrated in FIG. 2 cut along the III-III line. The middle frame 6 is located at a position which is between the table-top 5 guided into the opening part 124 of the gantry 120 and the bed supporting unit 12 and which does not overlap with the center in the width direction of the table-top 5. The middle frame 6 is moved in the longitudinal direction. Further, a cable (i.e., a group of cables) C, which serves as a transmitting unit for transmitting at least one of a received signal sent from an imaging unit (i.e., the MRI imaging unit 100 in the MRI apparatus 200) and a control signal to be sent to the imaging unit, is located at a position between the table-top 5 and the bed supporting unit 12 and overlapping with the center in the width direction of the table-top 5. The cable C is held by a lower part of the table-top 5. The position not overlapping with the center in the width direction of the table-top 5 generally refers to the position which does not intervene the location of the cable C or the like located at the position overlapping with the center in the width direction of the table-top 5.

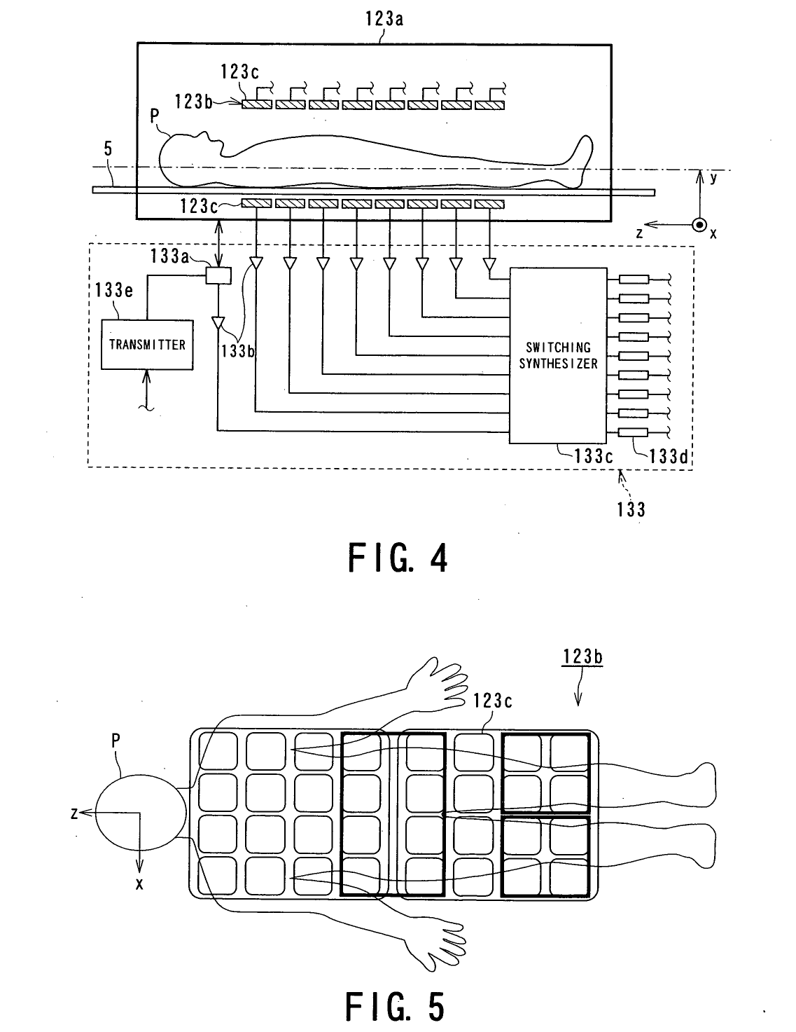

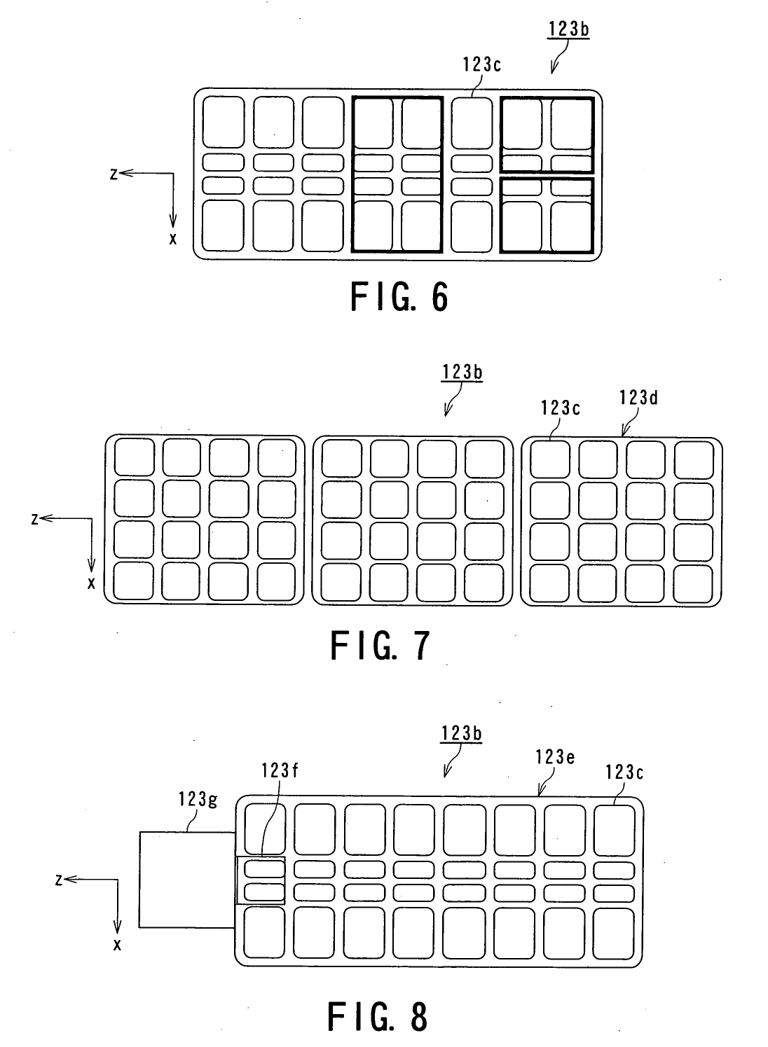

FIG. 4 is a diagram illustrating a configuration example of the RF coil 123 and the RF transmitting and receiving unit 133 illustrated in FIG. 1. FIG. 5 is a diagram illustrating a location example of surface coils 123c provided on the body surface side of the object P illustrated in FIG. 4. FIG. 6 is a diagram illustrating a location example of the surface coils 123c provided on the back surface side of the object P illustrated in FIG. 4.

As illustrated in FIG. 4, the RF coil 123 has a whole body (WB) coil 123a for the entire body and a phased array coil 123b. The phased array coil 123b has a plurality of the surface coils 123c, which are located on the body surface side and the back surface side of the object P, respectively.

For example, as illustrated in FIG. 5, a total of thirty two surface coils 123c are located on the body surface side of the object P, being arranged in four columns in the x-axis direction (i.e., the width direction) and eight columns in the z-axis direction (i.e., the longitudinal direction) so as to cover a wide range of areas to be imaged. Further, as illustrated in FIG. 6, a total of thirty two surface coils 123c are similarly located on the back surface side of the object P, being arranged in four columns in the x-axis direction and eight columns in the z-axis direction so as to cover a wide range of areas to be imaged. From the perspective of improvement of sensitivity in consideration of the presence of the spine of the object P, surface coils 123c of a smaller size than the size of other surface coils 123c are located near the body axis of the object P.

Meanwhile, the RF transmitting and receiving unit 133 illustrated in FIG. 4 has a duplexer 133a, amplifiers 133b, a switching synthesizer 133c, receiving circuits 133d, and a transmitter 133e. The duplexer 133a is connected to the transmitter 133e, the WB coil 123a, and an amplifier 133b for the WB coil 123a. The number of the amplifiers 133b to be provided corresponds to the number of the WB coil 123a and the respective surface coils 123c, and the amplifiers 133b are individually connected to the WB coil 123a and the respective surface coils 123c. The number of the switching synthesizer 133c to be provided is one or more than one. The input side of the switching synthesizer 133c is connected to the WB coil 123a or the respective surface coils 123c via a plurality of the amplifiers 133b. The number of the receiving circuits 133d to be provided is a desired number equal to or smaller than the number of the WB coil 123a and the respective surface coils 123c, and the receiving circuits 133d are provided to the output side of the switching synthesizer 133c.

The WB coil 123a can be used as a coil for transmitting the high frequency signal. Further, the respective surface coils 123c can be used as coils for receiving a nuclear magnetic resonance (NMR) signal. Furthermore, the WB coil 123a can be used as a receiver coil.

Therefore, the duplexer 133a is configured to provide the WB coil 123a with the transmission high frequency signal output from the transmitter 133e, and to provide the switching synthesizer 133c with the NMR signal received by the WB coil 123a, via the corresponding amplifier 133b in the RF transmitting and receiving unit 133. Further, it is configured such that the NMR signals received by the respective surface coils 123c are output to the switching synthesizer 133c via the respective corresponding amplifiers 133b.

The switching synthesizer 133c is configured to perform synthesis processing and switching of the NMR signals received from the WB coil 123a and the respective surface coils 123c, and to output to the corresponding receiving circuits 133d. In other words, it is configured such that the synthesis processing and the switching of the NMR signals received from the WB coil 123a and the respective surface coils 133c are performed in the switching synthesizer 133c in accordance with the number of the receiving circuits 133d, and that a sensitivity distribution in accordance with the areas to be imaged is formed by using a desired plural number of the surface coils 123c so as to receive the NMR signals from a variety of imaged areas.

Alternatively, it may be configured such that the surface coils 123c are not provided, and that solely the WB coil 123a receives the NMR signal. Further, it may be configured such that the switching synthesizer 133c is not provided, and that the NMR signals received by the WB coil 123a and the respective surface coils 123c are directly output to the receiving circuits 133d. Furthermore, it is possible to locate a larger number of the surface coils 123c over a wide range of areas.

FIG. 7 is a diagram illustrating another location example of the surface coils 123c provided on the body surface side of the object P illustrated in FIG. 4. FIG. 8 is a diagram illustrating another location example of the surface coils 123c provided on the back surface side of the object P illustrated in FIG. 4.

As illustrated in FIGS. 7 and 8, a further larger number of the surface coils 123c can be located around the object P. In the example illustrated in FIG. 7, three coil units 123d, each of which includes sixteen surface coils 123c arranged in four columns in the x-axis direction and four columns in the z-axis direction, are located in the z-axis direction. That is, a total of forty eight surface coils 123c are provided on the body surface side of the object P. Further, in the example illustrated in FIG. 8, a coil unit 123e, which includes thirty two surface coils 123c arranged in four columns in the x-axis direction and eight columns in the z-axis direction, is located on the spine side. Meanwhile, a coil unit 123f, which includes two surface coils 123c (not illustrated), is located near the jaw position, and a coil unit 123g, which includes twelve surface coils 123c (not illustrated), is located at the head position. That is, a total of forty six surface coils 123c are provided on the back surface side of the object P. As illustrated in FIGS. 7 and 8, if the surface coils 123c are located on the body surface side and the back surface side of the object P, a total of ninety four surface coils 123c are located around the object P. The respective surface coils 123c are connected to the respective own amplifiers 133b via coil ports (not illustrated).

With a large number of the surface coils 123c thus located around the object P, it becomes possible to form the phased array coil 123b for the entire body capable of receiving data from a plurality of imaged areas without moving the position of the coil or the object P. The WB coil 123a can also receive the data from the plurality of imaged areas without moving the position of the coil or the object P. However, if the phased array coil 123b for the entire body is used as the receiver coil, the data can be received with a better signal to noise ratio (SNR) and with sensitivity more appropriate for the imaged areas.

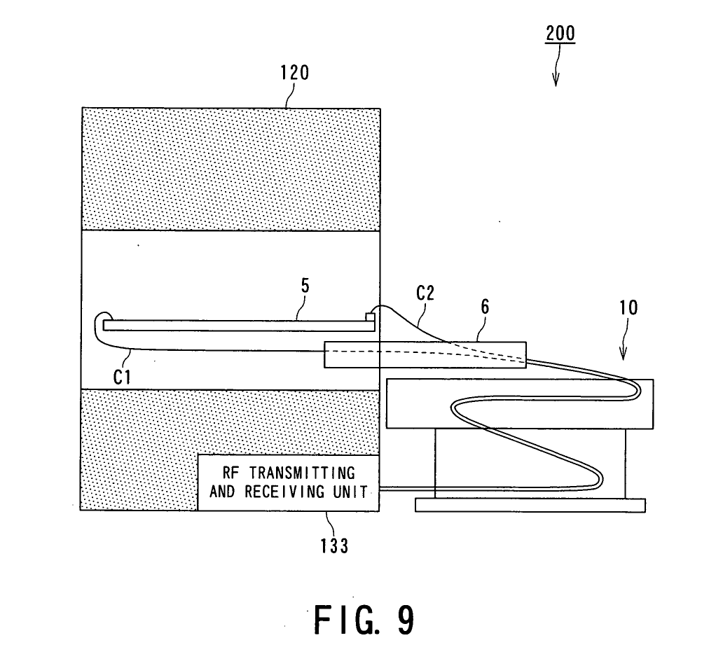

FIG. 9 is a side view illustrating a wiring example of the cable C which transmits the received signal and the control signal between the RF coil 123 and the RF transmitting and receiving unit 133 illustrated in FIG. 1.

As illustrated in FIG. 9, a cable C1 extending from the head side of the table-top 5 (i.e., the left side in FIG. 9) and a cable C2 extending from the lower leg side of the table-top 5 (i.e., the right side in FIG. 9) pass through a side of the middle frame 6 below the table-top 5 and are connected to the RF transmitting and receiving unit 133 via the bed unit 10. In FIG. 9, only the two cables C1 and C2 are illustrated for the convenience sake. Even if there are three or more of the cables C, all of the cables C pass through a side of the middle frame 6 below the table-top 5 and are connected to the RF transmitting and receiving unit 133 via the bed unit 10.

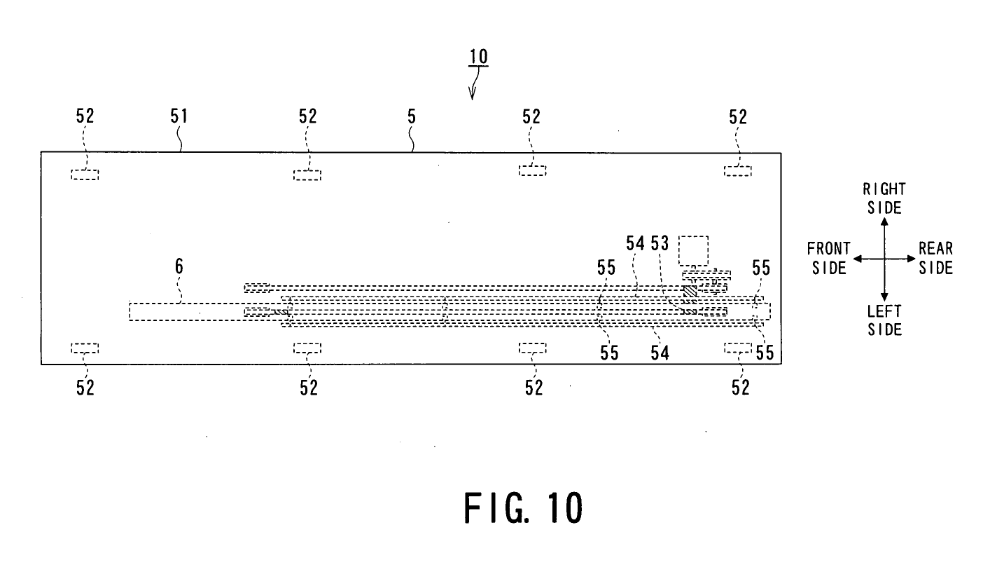

With reference to FIGS. 10 to 18, a detailed configuration of the bed moving unit 1 and the mechanical unit 2 of the bed unit 10 will be described.

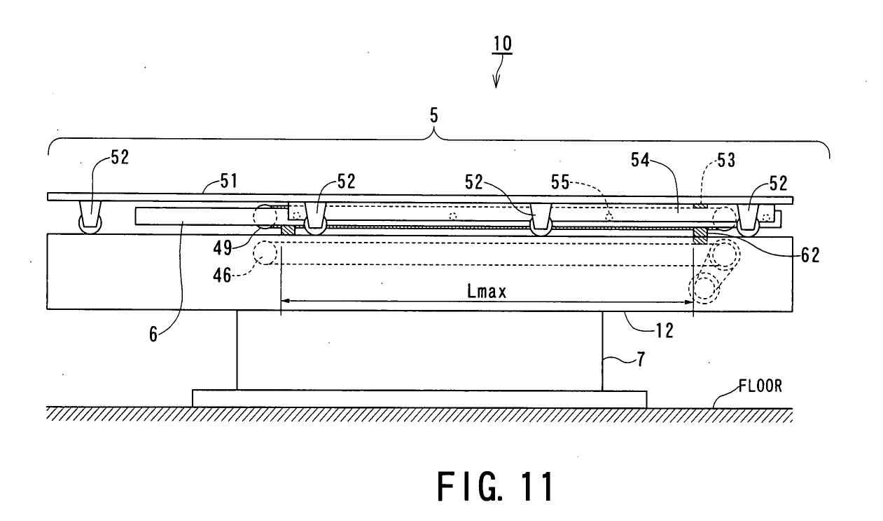

FIGS. 10 and 11 are diagrams illustrating the detailed configuration of the table-top 5 in the horizontal moving unit 11 of the bed moving unit 1. FIG. 10 is a view of the bed unit 10 as viewed from the above, and FIG. 11 is a side view of bed unit 10. FIGS. 10 and 11 illustrate the position of the table-top 5 when the bed unit 10 is in the home position thereof. In the following description, a left side, a right side, an upper side, and a lower side of the bed unit 10 illustrated in FIGS. 10 and 11 will be referred to as a front side, a rear side, a right side, and a left side, respectively.

The table-top 5 has a rectangular table-top body 51 on which the object P is mounted, wheeled support legs 52 for smoothing the movement of the table-top body 51 in the longitudinal direction toward the front side and the rear side, a table-top connecting portion 53 for transmitting the drive force transmitted from the horizontal moving mechanical unit 4 to the table-top body 51, and two middle frame holding portions 54 for holding the middle frame 6.

A plurality of the wheeled support legs 52 are held at regular intervals over entire areas near the opposite ends on the longer sides of the lower surface of the table-top body 51. The wheeled support legs 52 enable the table-top body 51 to smoothly move on the bed supporting unit 12 in the longitudinal direction. Further, in the opening part 124 formed in the gantry 120 of the MRI imaging unit 100, the table-top body 51 can smoothly move on rails 125 in the longitudinal direction.

The table-top connecting portion 53 is located to the lower surface of the table-top body 51 near the rear-side end thereof, and connects the table-top body 51 to a part of the horizontal moving mechanical unit 4. Thus, the table-top connecting portion 53 transmits the drive force transmitted from the horizontal moving mechanical unit 4 to the table-top body 51, and causes the table-top 5 to move from the home position thereof toward the front side.

To axially support a plurality of rollers 55, the two middle frame holding portions 54 are fixed to the lower surface of the table-top body 51 at the left and right sides of the table-top connecting portion 53 to be parallel to and apart from each other. The plurality of the rollers 55 respectively engaging with the middle frame 6 are held on facing surfaces of the two middle frame holding portions 54, which are held parallel to each other. Thereby, the middle frame 6 is held via the rollers 55 to be movable in the longitudinal direction.

When the object P is mounted on the table-top body 51 of the bed unit 10 of the above configuration and the horizontal moving mechanical unit 4 is driven, the table-top body 51 is driven via the middle frame 6 and the table-top connecting portion 53. Then, due to the rotation of the wheeled support legs 52, the table-top body 51 can be smoothly moved on the bed supporting unit 12 in the longitudinal direction (the front and rear directions).

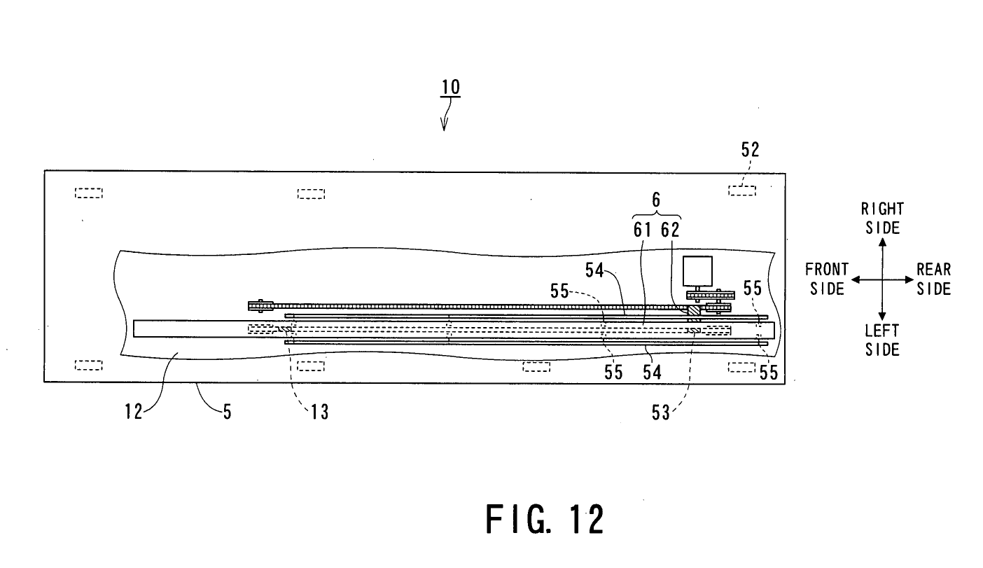

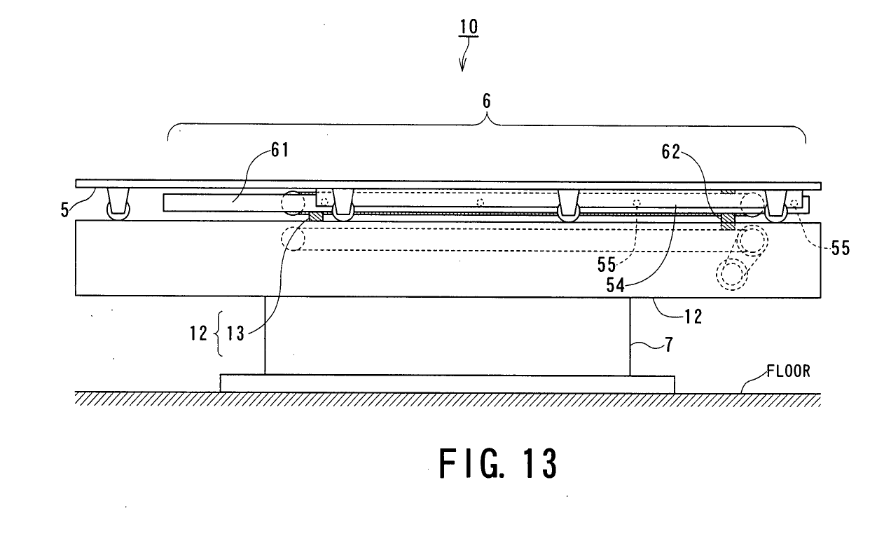

FIGS. 12 and 13 are diagrams illustrating a detailed configuration of the middle frame 6 of the horizontal moving unit 11. FIG. 12 is a cutaway view of an upper part of the bed unit 10, and FIG. 13 is a side view of the bed unit 10. FIGS. 12 and 13 illustrate the position of the middle frame 6 when the bed unit 10 is in the home position thereof.

The middle frame 6 is provided in a space formed between the table-top 5 and the bed supporting unit 12, and has a middle frame body 61 located below the table-top 5 and a middle frame connecting portion 62 for transmitting the drive force transmitted from the horizontal moving mechanical unit 4 to the middle frame body 61.

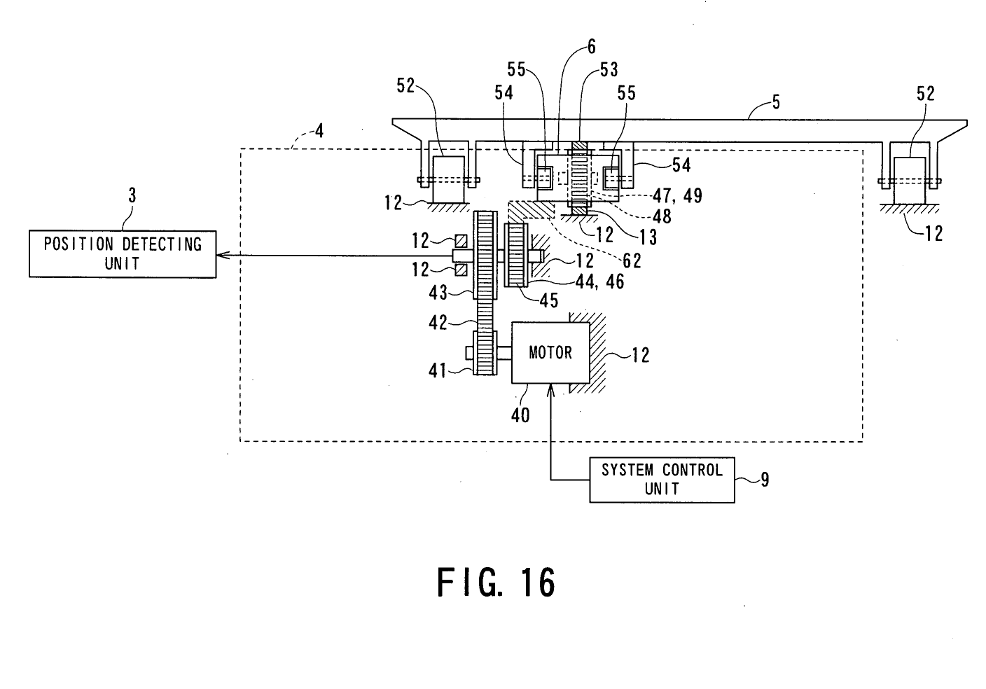

The middle frame body 61 is located parallel to the longitudinal direction of the lower surface of the table-top 5. The front-side end of the middle frame body 61 is located at the rear of the front-side end of the table-top 5, and the rear-side end of the middle frame body 61 is located at the front of and in the vicinity of the rear-side end of the table-top 5. Further, as illustrated in FIG. 16, a vertical cross section in the width direction of the table-top 5 forms an I-shape (T-shape or the like), and the rollers 55 engage with the middle frame holding portions 54 of the table-top 5 at opposite sides of the I-shaped cross section.

As illustrated in FIG. 16, the middle frame connecting portion 62 is located at the front of the rear-side end of the lower surface of the middle frame body 61, and is located at an obliquely lower right position of the table-top connecting portion 53 of the table-top 5. Thus, the middle frame connecting portion 62 connects the middle frame body 61 to a part of the horizontal moving mechanical unit 4. Thereby, the middle frame connecting portion 62 transmits the drive force transmitted from the horizontal moving mechanical unit 4 to the middle frame body 61, and causes the middle frame body 61 to move from the home position thereof toward the front side.

The bed supporting unit 12 is mounted with the wheeled support legs 52 of the table-top 5, and forms an upper surface of an approximately same rectangular shape as the shape of the table-top body 51. Further, the bed supporting unit 12 has the bed supporting unit connecting portion 13 for transmitting the drive force transmitted from the horizontal moving mechanical unit 4 to the middle frame 6 and the table-top 5, and supports the table-top 5 to be horizontally movable in the longitudinal direction.

The bed supporting unit connecting portion 13 is located at the rear of the front-side end of the middle frame body 61, and connects the bed supporting unit 12 to a part of the horizontal moving mechanical unit 4. The bed supporting unit connecting portion 13 is provided to transmit the drive force transmitted from the horizontal moving mechanical unit 4 to the middle frame body 61.

It may be configured such that the height of the wheeled support legs 52 of the table-top 5 is reduced to lower the position of the table-top 5, and that an area of the upper surface of the bed supporting unit 12 encircled by the contact surfaces between the upper surface of the bed supporting unit 12 and the wheeled support legs 52 is depressed to store the middle frame 6 in the depressed area, with the middle frame 6 kept not in contact with the depressed surface. With this configuration, the bed moving unit 1 can be reduced in size.

Further, it may be configured such that the length in the width direction of the middle frame 6 is increased to held on the length-increased middle frame 6 the wheeled support legs 52 provided to the table-top 5, and that the middle frame 6 supports the table-top 5 to be movable in the longitudinal direction and the bed supporting unit 12 supports the middle frame 6 to be movable in the longitudinal direction. Furthermore, it may be configured such that the wheeled support legs 52 are held to the table-top 5 and the middle frame 6, and that the bed supporting unit 12 supports the table-top 5 and the middle frame 6 to be movable in the longitudinal direction.

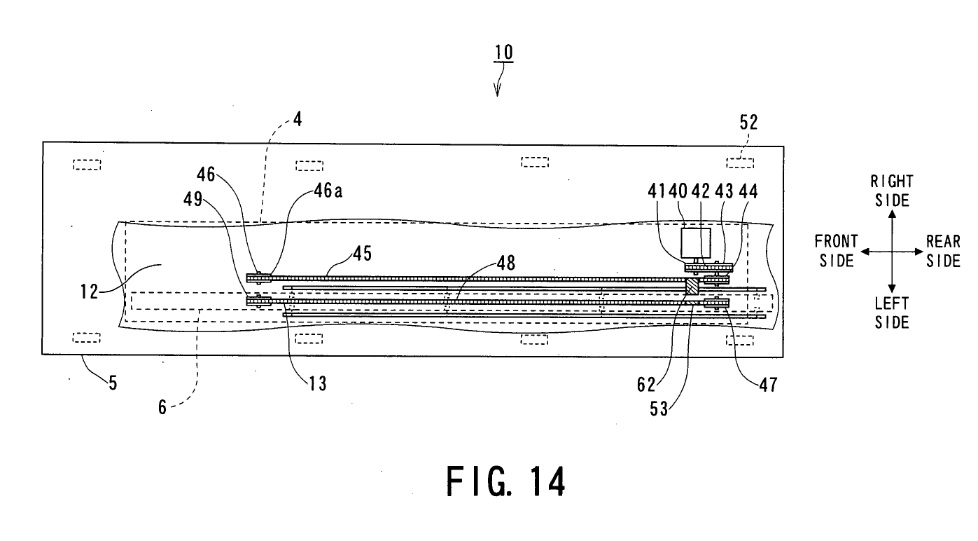

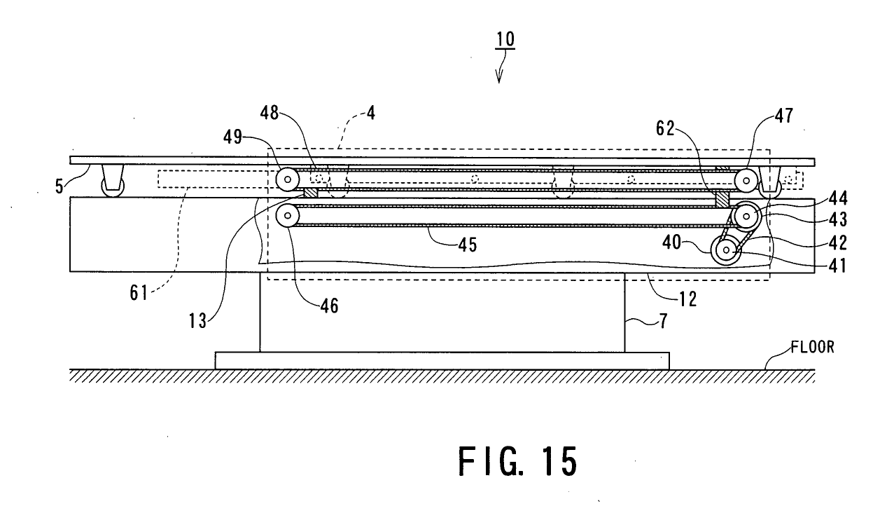

FIGS. 14 to 17 are diagrams illustrating a detailed configuration of the horizontal moving mechanical unit 4 of the mechanical unit 2. FIG. 14 is a configuration diagram, in which an upper part of the bed unit 10 is viewed from the above and the horizontal moving mechanical unit 4 is extracted. FIG. 15 is a configuration diagram, in which a lateral side of the bed unit 10 is viewed from the left side and the horizontal moving mechanical unit 4 is extracted. FIGS. 14 and 15 illustrate the horizontal moving mechanical unit 4 when the bed unit 10 is in the home position thereof. FIG. 16 is a configuration diagram illustrating an example of the horizontal moving mechanical unit 4, in which the bed unit 10 is viewed from the front side.

The horizontal moving mechanical unit 4 is located to the bed supporting unit 12 and the middle frame 6. Further, the horizontal moving mechanical unit 4 is held to the bed supporting unit 12. The mechanism of the horizontal moving mechanical unit 4 located to the bed supporting unit 12 has the motor 40 serving as a power source for driving the horizontal moving unit 11 to move the table-top 5, the drive pulley 41 for transmitting the drive force of the motor 40 to the belt 42, the input pulley 43 forming a pair with the drive pulley 41 for transmitting the drive force transmitted from the belt 42 to the output pulley 44, the belt 45 for transmitting the drive force transmitted from the output pulley 44 to the middle frame 6, the output pulley 44 wound around with the belt 45, and the idle pulley 46 forming a pair with the output pulley 44.

Meanwhile, the mechanism of the horizontal moving mechanical unit 4 located to the middle frame 6 has the belt 48 for transmitting the drive force transmitted to the middle frame 6 from the belt 45 to the table-top 5, and a pair of the idle pulleys 47 and 49 wound around with the belt 48.

The pair of the drive pulley 41 and the input pulley 43 and the belt 42 therebetween, the pair of the output pulley 44 and the idle pulley 46 and the belt 45 therebetween, and the pair of the idle pulleys 47 and 49 and the belt 48 therebetween are respectively formed with meshing cogs to transmit the drive force. The idle pulleys 46 and 49 are located at the same position in the home positions thereof, and the output pulley 44 and the idle pulley 47 are located at the same position in the home positions thereof. Further, the lower belt 45 and the upper belt 48 have the same in length.

The motor 40 is fixed to the bed supporting unit 12. Such factors as the number, the direction, and the speed of rotations of the motor 40 are controlled by the system control unit 9. The belt 42 is wound around the input pulley 43 and the drive pulley 41 fixed to the rotary shaft of the motor 40, and transmits the drive force of the motor 40 to the input pulley 43 via the drive pulley 41 and the belt 42.

The input pulley 43 having a larger number of cogs than the number of cogs of the drive pulley 41 is located at the rear of and in the vicinity of the middle frame connecting portion 62 of the middle frame 6 such that the rotary shaft of the input pulley 43 becomes horizontal and parallel to the width direction of the bed supporting unit 12, and the input pulley 43 is rotatably held by the bed supporting unit 12. Thus, the input pulley 43 transmits the drive force transmitted from the belt 42 to the output pulley 44. The output pulley 44, which shares the rotary shaft with the input pulley 43, rotates in the same direction and by the same number of rotations as the input pulley 43, and transmits the drive force transmitted from the input pulley 43 to the belt 45.

The belt 45 is located such that the belt 45 becomes parallel to the longitudinal direction of the bed supporting unit 12, and that the upper and lower belt surfaces of the belt 45 become horizontal. Further, the belt 45 is wound between the output pulley 44 and the idle pulley 46. A part of the upper side of the belt 45 in the vicinity of the output pulley 44 is connected to the middle frame body 61 by the middle frame connecting portion 62. Thus, the drive force transmitted from the output pulley 44 is transmitted via the middle frame connecting portion 62 to the middle frame body 61 to horizontally move the middle frame 6 in the longitudinal direction.

The belt 48 is located in the vicinity of the upper and lower surfaces in the longitudinal direction of the middle frame body 61 such that the upper and lower belt surfaces of the belt 48 become horizontal. Further, the belt 48 is wound around the idle pulleys 47 and 49, which are held by the middle frame 6 to be rotationally movable. A part of the upper side of the belt 48 in the vicinity of the idle pulley 47 is connected to the table-top 5 by the table-top connecting portion 53, and a part of the lower side of the belt 48 in the vicinity of the idle pulley 49 is connected to the bed supporting unit 12 by the bed supporting unit connecting portion 13. Thus, the drive force transmitted from the belt 45 to the middle frame body 61 is transmitted to the table-top body 51 via the bed supporting unit connecting portion 13 and the table-top connecting portion 53. Thereby, the table-top 5 is horizontally moved in the same direction as the middle frame 6.

As illustrated in FIG. 16, the position detecting unit 3 is provided to the input pulley 43 of the horizontal moving mechanical unit 4. The position detecting unit 3 detects the direction and the number of rotations of the input pulley 43 by using an encoder or the like, and outputs the detected direction and number of rotations of the input pulley 43 to the system control unit 9. On the basis of the signal output from the position detecting unit 3, the system control unit 9 controls the motor 40 of the horizontal moving mechanical unit 4 to set the position of the table-top 5.

The thus configured horizontal moving mechanical unit 4 has a single simple structure, and is capable of horizontally moving the middle frame 6 of the horizontal moving unit 11 in the longitudinal direction and horizontally moving the table-top 5 in the same direction as the middle frame 6.

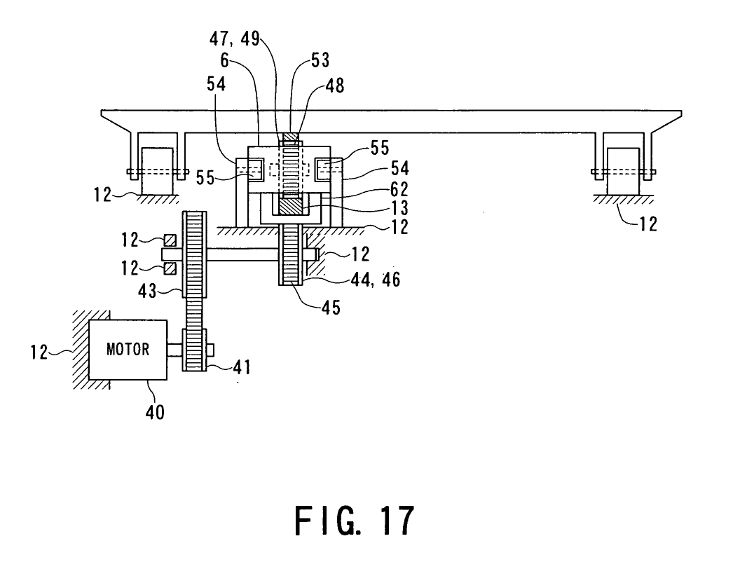

FIG. 17 is a configuration diagram illustrating another example of the horizontal moving mechanical unit 4, in which the bed unit 10 is viewed from the front side.

The configuration diagram illustrated in FIG. 17 is another example of the configuration diagram illustrated in FIG. 16. The configuration illustrated in FIG. 17 is different from the configuration illustrated in FIG. 16 in that the middle frame 6 is movably held by the bed supporting unit 12 via the middle frame holding portions 54. In the case illustrated in the configuration diagram of FIG. 17, the middle frame 6 is held by the bed supporting unit 12 fixed to the floor. Thus, the middle frame 6 is more stably held than in the case illustrated in the configuration diagram of FIG. 16.

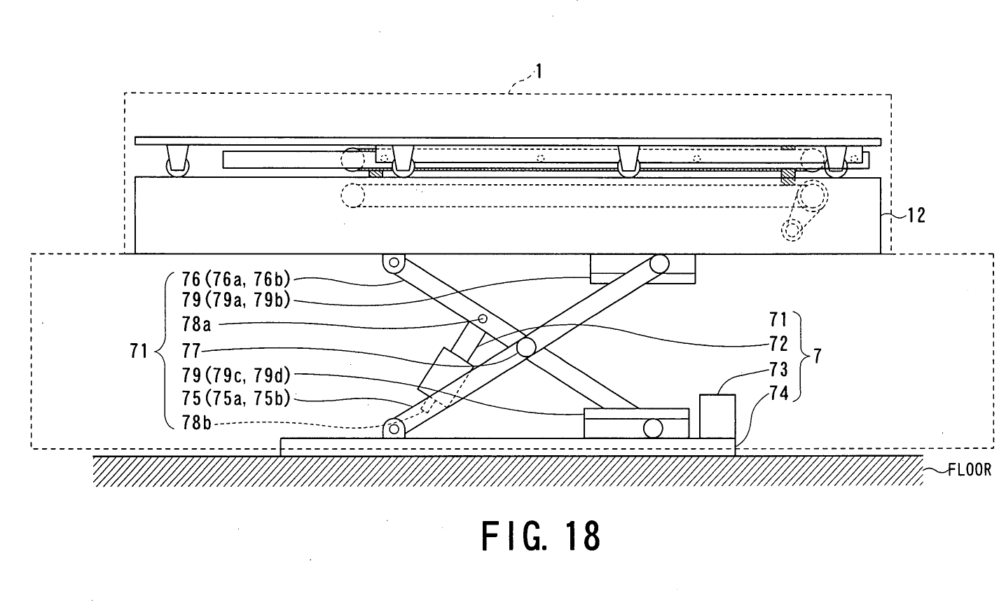

FIG. 18 is a side view illustrating a detailed configuration of the vertical moving mechanical unit 7. The vertical moving mechanical unit 7 is located between the bed supporting unit 12 of the bed moving unit 1 and the floor, and has a link mechanism 71 for vertically moving the bed moving unit 1, a hydraulic unit 73 for driving the link mechanism 71 via a hydraulic cylinder 72, and a rectangular link base 74 for supporting the link mechanism 71 and the hydraulic unit 73.

The link mechanism 71 has four arms of arms 75 (75a and 75b) and arms 76 (76a and 76b), a rotary shaft 77 of the arms 75 and 76, two support shafts 78 (78a and 78b) for supporting the hydraulic cylinder 72, and four guides 79 (79a to 79d) for holding end portions of the arms 75 and 76.

The arms 75 have the arm 75a and the arm 75b of the same length (the arm 75b is hidden behind the arm 75a in FIG. 18), and one ends of the arms 75 are held to be rotationally movable at the opposite ends in the width direction of the link base 74. Meanwhile, the other ends of the arms 75 are held to be slidable in the horizontal direction by the guides 79a and 79b of the guides 79 provided on the opposite ends in the width direction of the lower surface of the bed supporting unit 12 (the guide 79b is hidden behind the guide 79a in FIG. 18).

The arms 76 are the same in length as the arms 75a and 75b, and have the arm 76a and 76b which intersect with the arms 75a and 75b, respectively, at the center thereof (the arm 76b is hidden behind the arm 76a in FIG. 18). One ends of the arms 76a and 76b are positioned above the one ends of the arm 75a and 75b, and are held to be rotationally movable by the lower surface of the bed supporting unit 12. Meanwhile, the other ends of the arms 76a and 76b are positioned below the other ends of the arms 75a and 75b, and are held to be slidable in the horizontal direction by the guides 79c and 79d of the guides 79 held on the link base 74 (the guide 79d is hidden behind the guide 79c in FIG. 18).

The rotary shaft 77 has one end loosely fit and held in a hole formed in an intersection area of the arms 75a and 76a, and the other end fit and held in a hole formed in an intersection area of the arms 76b and 75b.

The support shafts 78 have the horizontally held support shafts 78a and 78b. One end of the support shaft 78a is fixed above the intersection area of the arm 76a with the arm 75a, while the other end of the support shaft 78a is fixed above the intersection area of the arm 76b with the arm 75b.

Further, one end of the support shaft 78b of the support shafts 78 is fixed below the intersection area of the arm 75a with the arm 76a, while the other end of the support shaft 78b is fixed below the intersection area of the arm 75b with the arm 76b.

One end and the other end of the hydraulic cylinder 72 are stretchably held at a center area between the support shafts 78a and 78b of the link mechanism 71.

The hydraulic unit 73 has a hydraulic pump for sending hydraulic oil to the hydraulic cylinder 72, a switching valve (not illustrated), and so forth, and adjusts the length of the hydraulic cylinder 72.

In the thus configured vertical moving mechanical unit 7, the hydraulic unit 73 is controlled by the system control unit 9 to expand and contract the hydraulic cylinder 72 for driving the support shafts 78a and 78b of the link mechanism 71. Due to the thus generated drive force, the respective one ends of the arms 75 and 76 rotationally move around the rotary shaft 77, and the other ends of the arms 75 and 76 slide the guides 79. Accordingly, the bed moving unit 1 is moved in the vertical direction.

With reference to FIGS. 1 to 22, the operation of the bed unit 10 will be then described.

When the object P to be subjected to the MRI imaging by the MRI imaging unit 100 is mounted on the table-top 5 of the bed unit 10 and thereafter a vertical position setting operation of the bed moving unit 1 is instructed by the operation unit 8, the system control unit 9 controls the vertical moving mechanical unit 7 to set the bed moving unit 1 at a position at which the upper surface of the bed supporting unit 12 of the bed moving unit 1 is aligned in height with the rails 125 provided in the opening part 124 of the gantry 120 of the MRI imaging unit 100.

Then, when a table-top position setting operation is instructed by the operation unit 8 to move the object P to the imaging position in the opening part 124, the system control unit 9 controls the horizontal moving mechanical unit 4 to move the horizontal moving unit 11 and set the table-top 5 at the imaging position in the opening part 124. Further, after completion of the MRI imaging, when a table-top home-positioning operation is instructed by the operation unit 8, the system control unit 9 controls the horizontal moving mechanical unit 4 to horizontally move the horizontal moving unit 11 to the home position of the bed supporting unit 12.

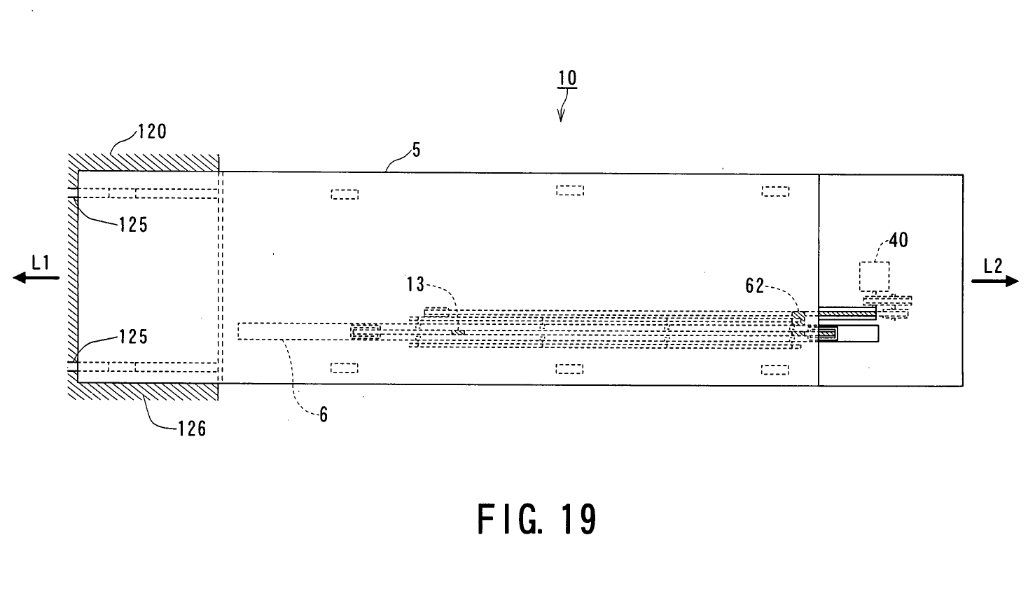

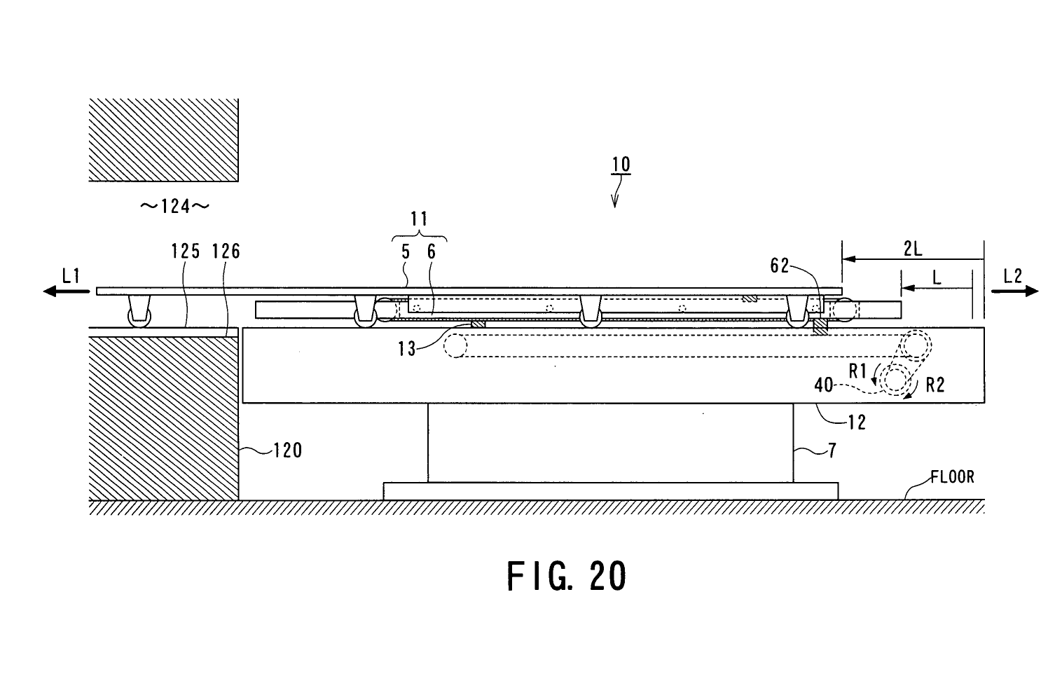

FIGS. 19 and 20 are diagrams illustrating the table-top 5 moving to the imaging position in the opening part 124. When an operation to move the table-top 5 from the home position thereof toward the direction of an arrow L1 by a distance 2L, for example, is instructed by the operation unit 8, the system control unit 9 instructs the horizontal moving mechanical unit 4 to set the position of the table-top 5.

In accordance with the instruction sent by the system control unit 9, the horizontal moving mechanical unit 4 causes the motor 40 to rotate in the direction of an arrow R1. Thereby, the horizontal moving unit 11 is horizontally moved from the home position thereof toward the direction of L1. Then, the middle frame 6 is set at a position apart from the home position thereof by a distance L, and the table-top 5 is set at a position apart from the home position thereof by the distance 2L on the rails 125 in the opening part 124 and the bed supporting unit 12.

Further, when the table-top home-positioning operation is instructed by the operation unit 8, the horizontal moving mechanical unit 4 causes the motor 40 to rotate in the direction of an arrow R2. Thereby, the horizontal moving unit 11 is horizontally moved in the direction of L2 and set at the original home position thereof.

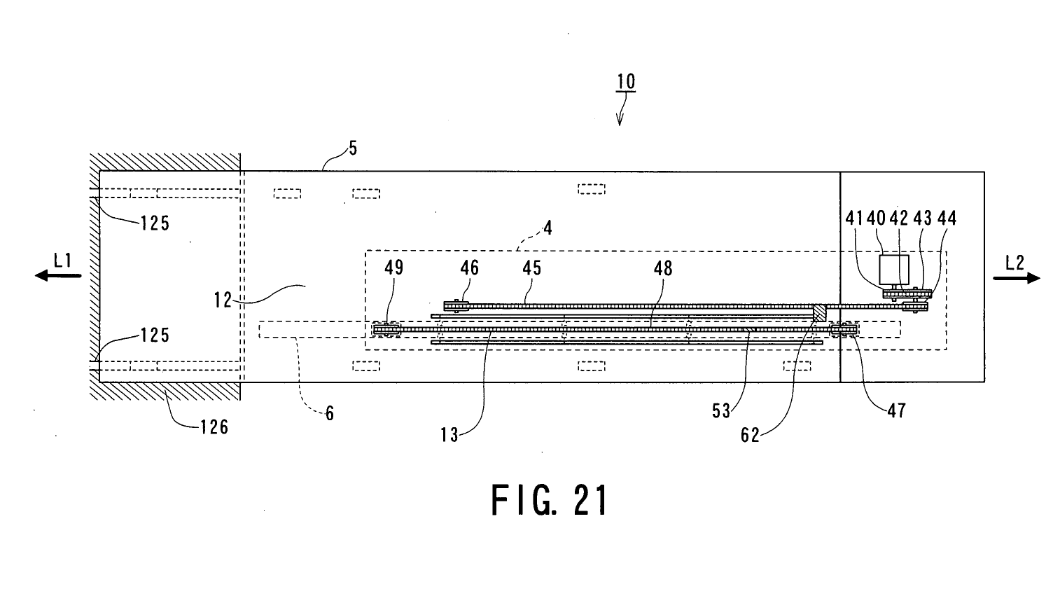

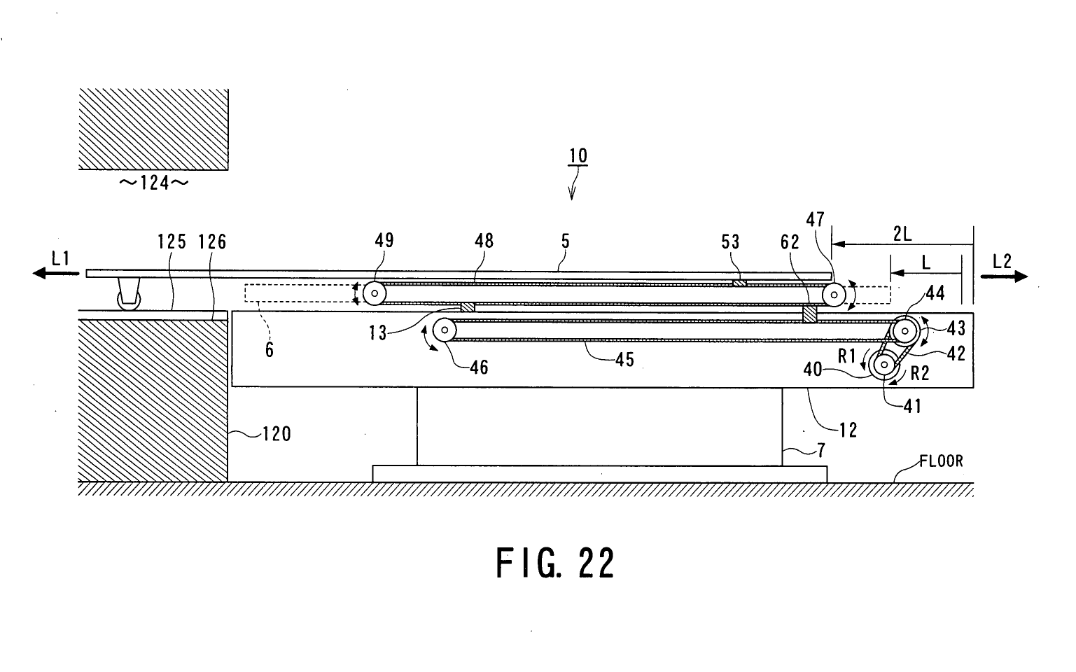

FIGS. 21 and 22 are diagrams for explaining the operation of the horizontal moving mechanical unit 4 in moving the horizontal moving unit 11 in the direction of L1. FIG. 21 is a view of an upper part of the bed unit 10 as viewed from the above, and FIG. 22 is a view of a lateral side of the bed unit 10 as viewed from the left side.

In the mechanism of the horizontal moving mechanical unit 4 located by the bed supporting unit 12, as the motor 40 is rotated in the direction of R1, the drive force for rotating the input pulley 43 and the output pulley 44 in the direction of R1 is transmitted via the drive pulley 41 and the belt 42. Then, the drive force of the output pulley 44 is transmitted as the drive force for moving the belt 45 in the direction of L1.

In the mechanism of the horizontal moving mechanical unit 4 located by the middle frame 6, the drive force for moving the middle frame 6 in the direction of L1 is transmitted by the drive force of the belt 45 to the middle frame body 61 connected to the belt 45 via the middle frame connecting portion 62. Then, due to the drive force of the middle frame body 61, the drive force in the direction of L1 is transmitted to the idle pulleys 47 and 49 held by the middle frame body 61.

Further, due to the drive force of the idle pulleys 47 and 49, the drive force in the direction of L1 is transmitted to the belt 48 wound around the idle pulleys 47 and 49. Since the belt 48 is connected to the bed supporting unit 12 via the bed supporting unit connecting portion 13, the drive force is transmitted as the drive force for rotating the idle pulleys 47 and 49 in the direction of R1 and moving the belt 48 in the direction of L1.

Then, due to the drive force of the belt 48, the drive force for moving the table-top 5 in the direction of L1 is transmitted to the table-top body 51 connected to the belt 48 via the table-top connecting portion 53. Thereby, the table-top 5 can move in the direction of L1.

The moving distances of the middle frame 6 and the table-top 5 will be then described. When the upper side of the belt 45 is moved in the direction of L1 by the distance L in accordance with a predetermined number of rotations of the motor 40 in the direction of R1, the middle frame body 61 connected to the belt 45 via the middle frame connecting portion 62 is also moved by the distance L. Then, as the middle frame 6 is moved, the upper side of the belt 48 is moved in the direction of L1 by the distance L. Further, the table-top 5 connected to the belt 48 via the table-top connecting portion 53 is moved above the middle frame body 61 in the direction of L1 by the distance L.

That is, the table-top 5 moves above the middle frame body 61 by the distance L while the middle frame body 61 moves in the direction of L1 by the distance L. Accordingly, the table-top 5 moves with respect to the bed supporting unit 12 in the same direction as the middle frame body 61 by the double distance 2L and twice as fast as the middle frame body 61, and the table-top 5 is set at a position more apart from the bed supporting unit 12 than the middle frame body 61 is.

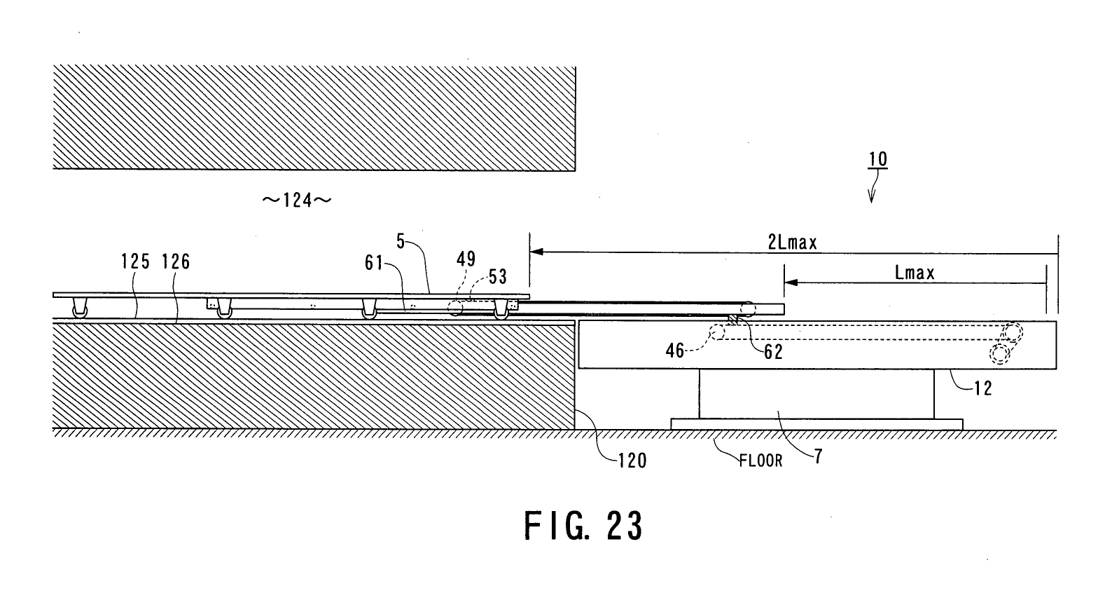

The middle frame body 61 can move within a range in which the middle frame connecting portion 62 moves from the home position thereof to reach the vicinity of the idle pulley 46. Further, the table-top 5 can move within a range in which the table-top connecting portion 53 moves from the home position thereof to reach the vicinity of the idle pulley 49. When a distance Lmax (Lmax>L) indicated in FIG. 23 represents the distance between the middle frame connecting portion 62 in the home position thereof and the vicinity of the idle pulley 46 and the distance between the table-top connecting portion 53 in the home position thereof and the vicinity of the idle pulley 49, the middle frame body 61 moves to a position above the bed supporting unit 12 and the bottom surface 126 of the opening part 124, which is apart from the home position of the middle frame body 61 in the direction of L1 by the distance Lmax, as illustrated in FIG. 23. Further, the table-top 5 moves to a position above the rails 125 in the opening part 124, which is apart from the home position of the table-top 5 in the direction of L1 by the distance 2Lmax, i.e., twice as long as the distance Lmax. In this manner, the table-top 5 can be set at the position in the opening part 124 apart from the bed supporting unit 12 by the distance 2Lmax.

If each of the distance between the middle frame connecting portion 62 in the home position thereof and the vicinity of the idle pulley 46 and the distance between the table-top connecting portion 53 in the home position thereof and the vicinity of the idle pulley 49 is increased to exceed the distance Lmax, the table-top 5 can be set at a position further apart from the home position thereof.

According to the above-described first embodiment of the present invention, the middle frame 6 and the bed supporting unit 12 are located below the table-top 5, and the bed supporting unit 12 and the middle frame 6 are located with the horizontal moving mechanical unit 4 of a single simple structure. Accordingly, the middle frame 6 can be moved together with the table-top 5 in the longitudinal direction. Further, due to the movement of the middle frame 6, the table-top 5 can be moved in the same direction as the middle frame 6 and set at a position more apart from the bed supporting unit 12 than the middle frame 6 is.

Accordingly, it is possible to prevent an increase in length in the longitudinal direction of the table-top 5, and thus to prevent an increase in size of the bed unit 10.

### Second Embodiment

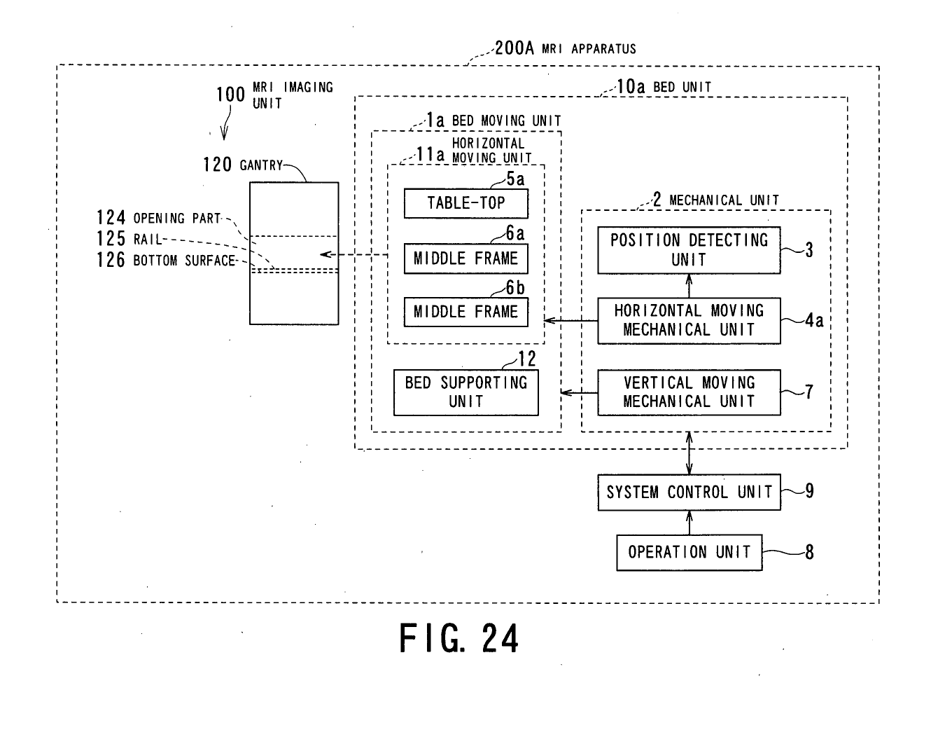

Description will be made below on a second embodiment of the bed unit of the MRI apparatus according to the present invention with reference to FIGS. 24 to 35. FIG. 24 is a block diagram illustrating a configuration of an MRI apparatus a bed apparatus) according to the second embodiment of the present invention.

FIG. 24 illustrates an MRI apparatus 200A according to the second embodiment of the present invention. The MRI apparatus 200A illustrated in FIG. 24 is different from the MRI apparatus 200 illustrated in FIG. 1 in that a bed moving unit 1a of a bet unit (i.e., a bed apparatus) 10a illustrated in FIG. 24 is provided with two middle frames 6a and 6b, and that a horizontal moving mechanical unit 4a enables the bed moving unit 1a to horizontally move in the longitudinal direction. Components of the same configuration as the components of the first embodiment are designated with the same reference numerals, and description thereof will be omitted. Further, FIGS. 3 to 9 are also applicable or correspondingly applicable to the MRI apparatus 200A.

The bed unit 10a of the MRI apparatus 200A has the bed moving unit 1a on which the object P is mounted, and a mechanical unit 2a for moving the bed moving unit 1a in the horizontal and vertical direction to set the object P in the opening part 124 of the gantry 120.

The bed moving unit 1a has a horizontal moving unit 11a and a bed supporting unit 12a for supporting the horizontal moving unit 11a. The horizontal moving unit 11a has a table-top 5a on which the object P is mounted, and the middle frames 6a and 6b for moving the table-top 5a onto the rails 125 in the opening part 124 of the gantry 120.

The mechanical unit 2a has the horizontal moving mechanical unit 4a for horizontally moving the horizontal moving unit 11a, the position detecting unit 3 for detecting the position of the horizontal moving unit 11a, and the vertical moving mechanical unit 7 for vertically moving the bed moving unit 1a.

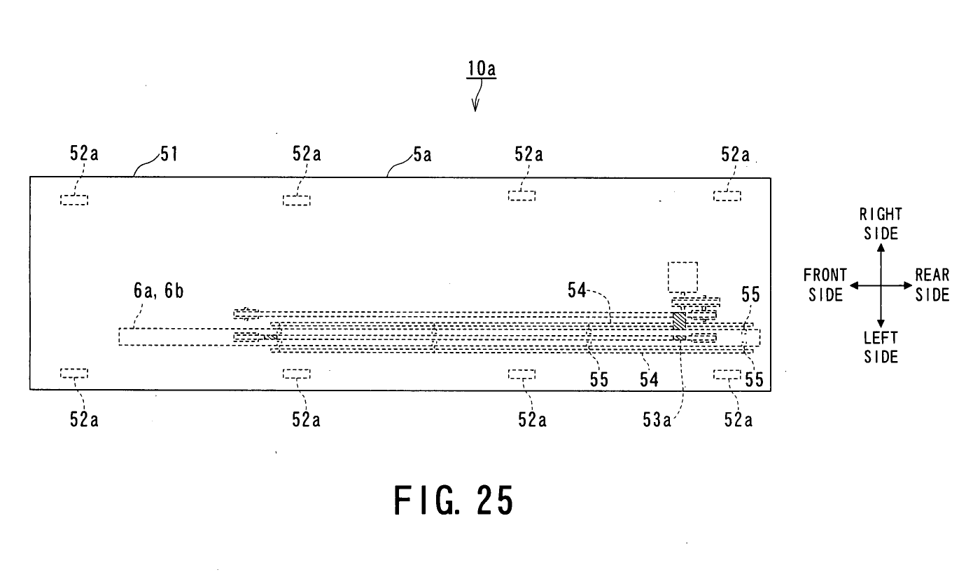

With reference to FIGS. 25 to 31, a detailed configuration of the bed moving unit 1a of the bed unit 10a and the horizontal moving mechanical unit 4a of the mechanical unit 2a will be described.

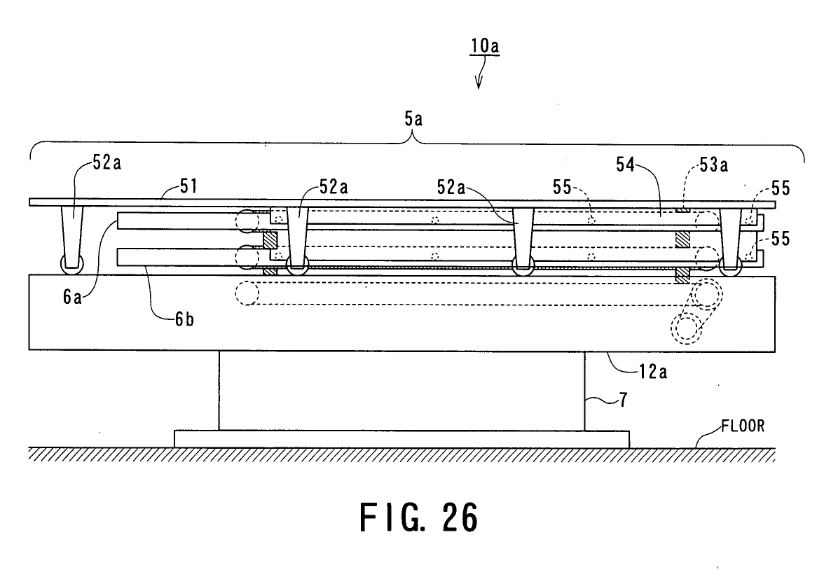

FIGS. 25 and 26 are diagrams illustrating a detailed configuration of the table-top 5a in the horizontal moving unit 11a of the bed moving unit 1a. FIG. 25 is a view of the bed unit 10a as viewed from the above, and FIG. 26 is a side view of the bed unit 10a. FIGS. 25 and 26 illustrate the position of the table-top 5a when the bed unit 10a is in the home position thereof.

The bed unit 10a of the MRI apparatus 200A has the table-top 5a which moves at least in the longitudinal direction (i.e., the lateral directions in FIGS. 25 and 26), the bed supporting unit 12a located below the table-top 5a, and a plurality of the middle frames (i.e., middle frames 6a and 6b) which are located at a position between the table-top 5a and the bed supporting unit 12a and not overlapping with the center in the width direction of the table-top 5a and which move in the longitudinal direction. For example, the bed unit 10a has the middle frame 6b which is located at a position between the table-top 5a and the bed supporting unit 12a and not overlapping with the center in the width direction of the table-top 5a and which moves in the longitudinal direction, and the middle frame 6a which is located at a position between the table-top 5a and the middle frame 6b and off the center in the width direction of the table-top 5a and which moves in the longitudinal direction. The bed unit 10a changes the relative positional relationship among the table-top 5a, the middle frame 6b, and the middle frame 6a while the middle frame 6b moves with respect to the bed supporting unit 12a. The table-top 5a is configured to have a longer length in the longitudinal direction than the length in the longitudinal direction of the middle frames 6a and 6b.

The table-top 5a has the table-top body 51, wheeled support legs 52a for smoothing the movement of the table-top body 51 in the longitudinal direction towards the front side and the rear side, a table-top connecting portion 53a for connecting the table-top body 51 to a part of the horizontal moving mechanical unit 4a at the same position as the position of the table-top body 51 of the first embodiment illustrated in FIGS. 10 and 11 to thereby transmit the drive force transmitted from the horizontal moving mechanical unit 4a to the table-top body 51, and the two middle frame holding portions 54 for holding the middle frame 6a via the rollers 55 to be movable in the longitudinal direction.

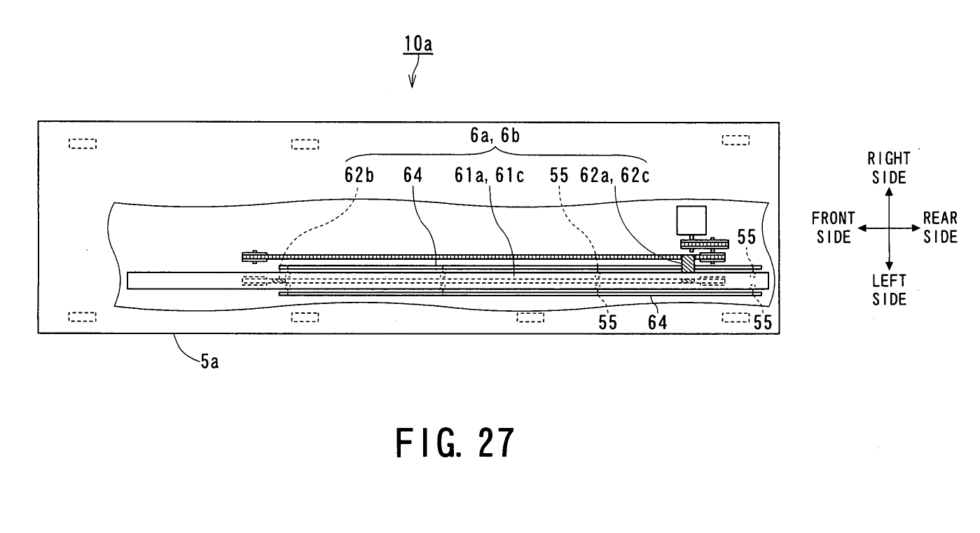

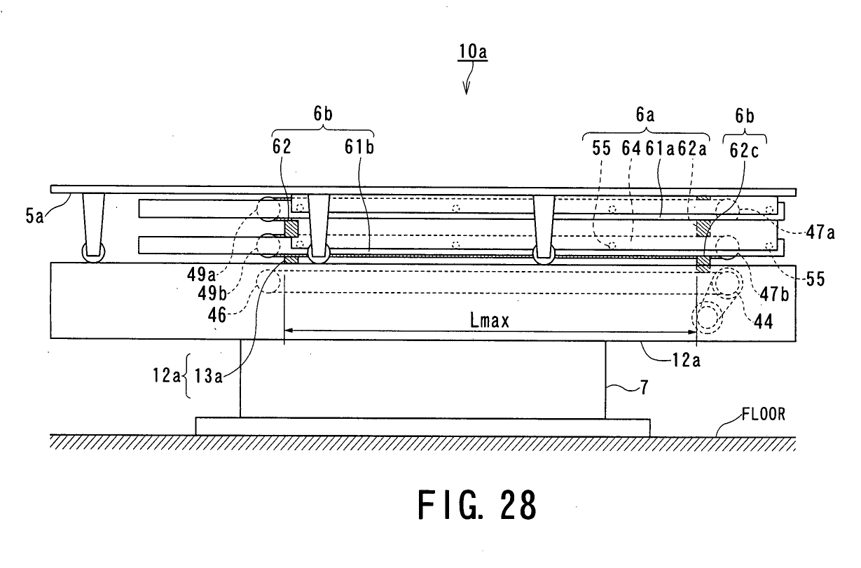

FIGS. 27 and 28 are diagrams illustrating a detailed configuration of the middle frames 6a and 6b of the horizontal moving unit 11a and the bed supporting unit 12a, which are had in the bed moving unit 1a. FIG. 27 is a cutaway view of the bed unit 10a as viewed from the above, and FIG. 28 is a side view of the bed unit 10a. The middle frames 6a and 6b illustrated in FIGS. 27 and 28 are set in the home positions thereof.

The middle frame 6a is provided in a space formed between the table-top 5a and the bed supporting unit 12a, and has a middle frame body 61a located below the table-top 5a, a middle frame connecting portion 62a for transmitting the drive force transmitted from the horizontal moving mechanical unit 4a to the middle frame body 61a, and two middle frame holding portions 64 for holding the middle frame 6b to be movable in the longitudinal direction.

The middle frame body 61a is the same in shape and size as the middle frame body 61 of the first embodiment illustrated in FIGS. 12 and 13, and is located at a similar position with respect to the table-top body 51 of the table-top 5a to the position of the middle frame body 61 with respect to the table-top body 51 of the first embodiment illustrated in FIGS. 12 and 13.

The middle frame connecting portion 62a is located below the table-top connecting portion 53a of the table-top 5a, and connects the middle frame body 61a to a part of the horizontal moving mechanical unit 4a. Thus, the middle frame connecting portion 62a transmits the drive force transmitted from the horizontal moving mechanical unit 4a to the middle frame body 61a, and causes the middle frame 6a to move from the home position thereof toward the front side.

To axially support the plurality of the rollers 55, the two middle frame holding portions 64 are respectively located below the middle frame holding portions 54 of the table-top 5a, and are fixed to the lower surface of the middle frame body 61a. The plurality of the rollers 55 respectively engaging with the middle frame 6b are located on facing surfaces of the two middle frame holding portions 64, which are located parallel to each other. Thereby, the middle frame 6b is held via the rollers 55 to be movable in the longitudinal direction.

The middle frame 6b is provided in a space formed between the table-top 5a and the bed supporting unit 12a, and has a middle frame body 61b located below the middle frame 6a, a middle frame connecting portion 62b for transmitting the drive force transmitted from the horizontal moving mechanical unit 4a to the middle frame body 61a and the table-top 5a, and a middle frame connecting portion 62c for transmitting the drive force transmitted from the horizontal moving mechanical unit 4a to the middle frame body 61b.

The middle frame body 61b is the same in shape and size as the middle frame body 61a, and is held via the middle frame holding portions 64 of the middle frame 6a to be movable in the longitudinal direction.

The middle frame connecting portion 62b is located below the middle frame connecting portion 62a, and connects the middle frame body 61b to a part of the horizontal moving mechanical unit 4a. Thus, the middle frame connecting portion 62b transmits the drive force transmitted to the middle frame 6b from the horizontal moving mechanical unit 4a to the middle frame body 61a via the horizontal moving mechanical unit 4a.

The middle frame connecting portion 62c is located below the middle frame connecting portion 62a, and connects the middle frame body 61b to a part of the horizontal moving mechanical unit 4a. Thus, the middle frame connecting portion 62c transmits the drive force transmitted from the horizontal moving mechanical unit 4a to the middle frame body 61b.

The bed supporting unit 12a is mounted with the wheeled support legs 52 of the table-top 5a, and forms an upper surface of an approximately same rectangular shape as the shape of the table-top body 51. Further, the bed supporting unit 12a is provided with a bed supporting unit connecting portion 13a for transmitting the drive force transmitted from the horizontal moving mechanical unit 4a to the middle frame body 61b, and supports the table-top 5a to be horizontally movable in the longitudinal direction.

The bed supporting unit connecting portion 13a is located below the middle frame connecting portion 62b, and connects the bed supporting unit 12a to a part of the horizontal moving mechanical unit 4a. The bed supporting unit connecting portion 13a is provided to transmit the driving force transmitted from the horizontal moving mechanical unit 4a to the middle frame body 61b.

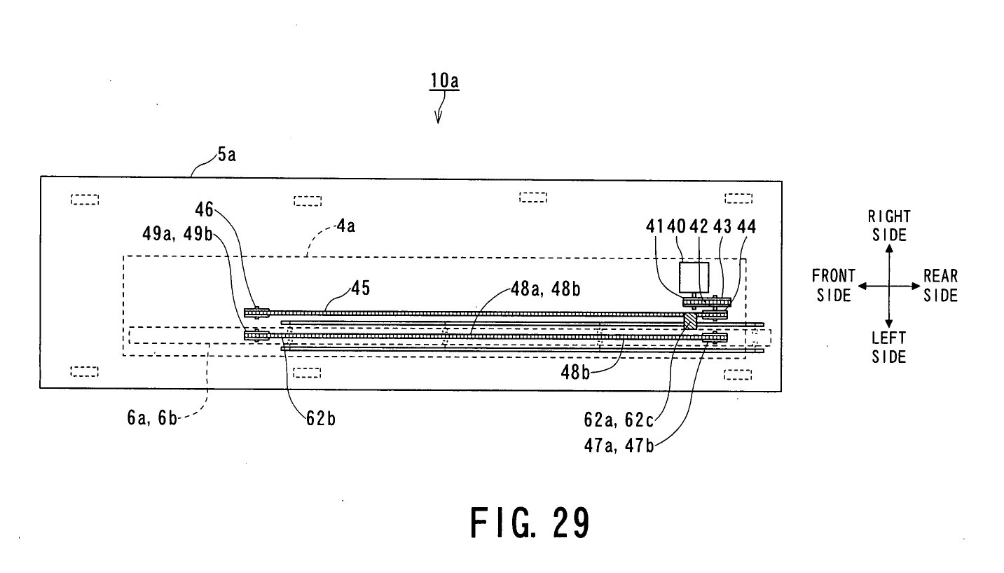

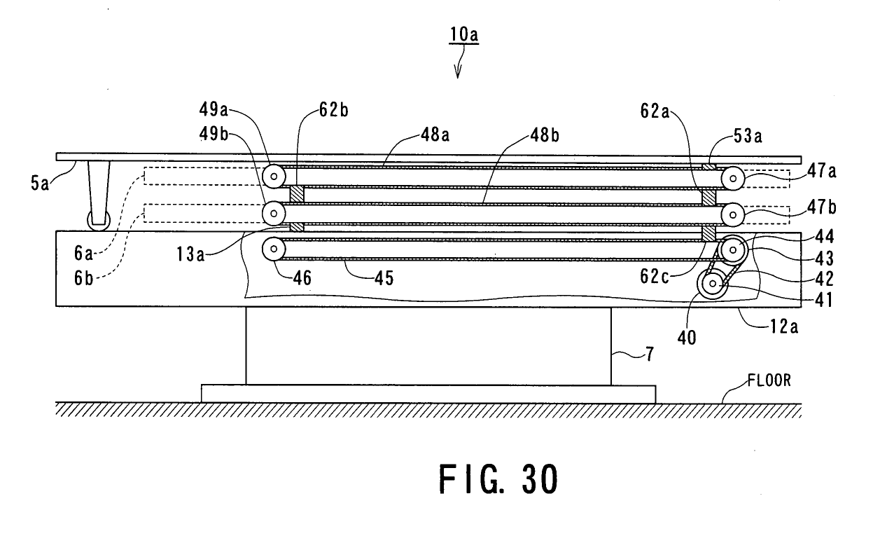

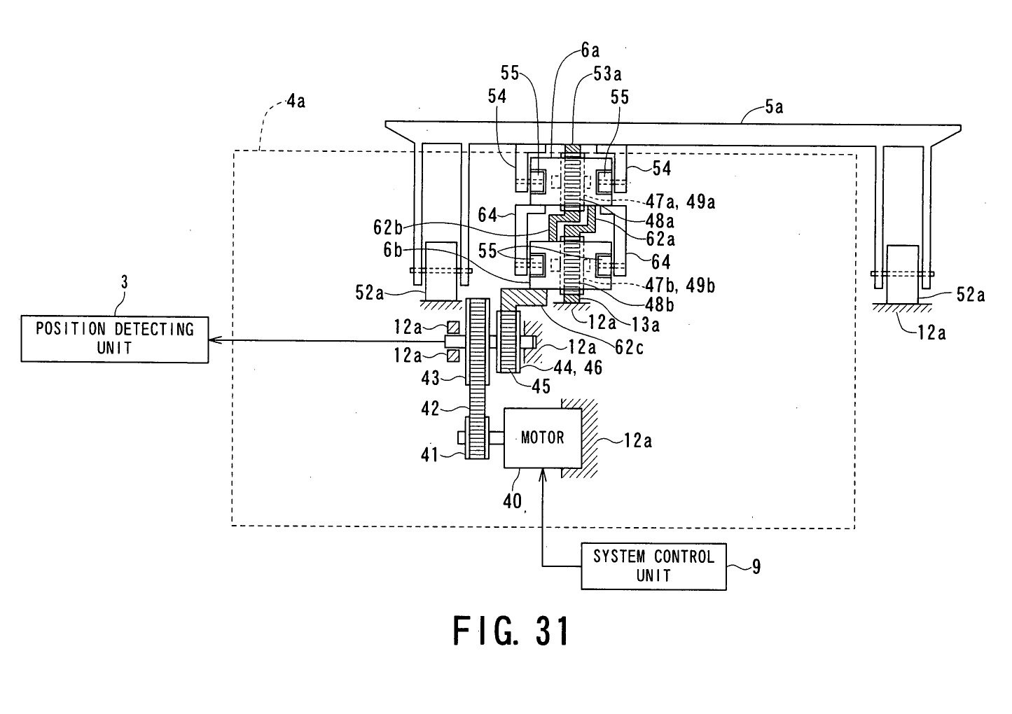

FIGS. 29 to 31 are diagrams illustrating a detailed configuration of the horizontal moving mechanical unit 4a. FIG. 29 is a configuration diagram, in which the bed unit 10a is viewed from the above and the horizontal moving mechanical unit 4a is extracted. FIG. 30 is a configuration diagram, in which a lateral side of the bed unit 10a is viewed from the left side and the horizontal moving mechanical unit 4a is extracted. FIGS. 29 and 30 illustrate the horizontal moving mechanical unit 4a when the bed unit 10a is in the home position thereof. FIG. 31 is a configuration diagram illustrating an example of the horizontal moving mechanical unit 4a, in which the bed unit 10a is viewed from the front side. In the configuration illustrated in FIG. 31, the middle frame 6a is held by the table-top 5a via the middle frame holding portions 54, and the middle frame 6b is held by the middle frame 6a via the middle frame holding portions 64. Although not illustrated, it may be configured such that the middle frame 6b is held by the bed supporting unit 12a, and that the middle frame 6a is held by the middle frame 6b. In this configuration, the middle frames 6a and 6b are held by the bed supporting unit 12a fixed to the floor. Thus, the middle frames 6a and 6b are more stably held than in the case illustrated in the configuration diagram of FIG. 31.

The horizontal moving mechanical unit 4a is located to the bed supporting unit 12a and the middle frames 6a and 6b. The mechanism of the horizontal moving mechanical unit 4a located to the bed supporting unit 12a has the motor 40, the drive pulley 41, the belt 42, the input pulley 43, the output pulley 44, the belt 45 for transmitting the drive force transmitted from the output pulley 44 to the middle frame 6b, and the idle pulley 46. The horizontal moving mechanical unit 4a is located to the bed supporting unit 12a in a similar manner to the horizontal moving mechanical unit 4 held to the bed supporting unit 12 of the first embodiment illustrated in FIGS. 14 to 17.

The mechanism of the horizontal moving mechanical unit 4a located to the middle frame 6b has a belt 48b for transmitting the drive force transmitted to the middle frame 6b from the belt 45 to the middle frame 6a, and a pair of idle pulleys 47b and 49b wound around with the belt 48b.

Further, the mechanism of the horizontal moving mechanical unit 4a located to the middle frame 6a has a belt 48a for transmitting the drive force transmitted to the middle frame 6a from the belt 48b to the table-top 5a, and a pair of idle pulleys 47a and 49a wound around with the belt 48a.

The pair of the idle pulleys 47b and 49b and the belt 48b therebetween, and the pair of the idle pulleys 47a and 49a and the belt 48a therebetween are respectively formed with meshing cogs to transmit the drive force. The idle pulleys 46, 49b, and 49a are located at the same position in the home positions thereof, and the output pulley 44 and the idle pulleys 47b and 47a are located at the same position in the home positions thereof. The lower belt 45, the intermediate belt 48b, and the upper belt 48a are the same in length.

A part of the upper side of the belt 45 in the vicinity of the output pulley 44 is connected to the middle frame 6b by the middle frame connecting portion 62c. Thus, the belt 45 transmits the drive force transmitted from the output pulley 44 to the middle frame body 61b via the middle frame connecting portion 62c, and causes the middle frame 6b to horizontally move in the longitudinal direction.

The belt 48b is located in the vicinity of the upper and lower surfaces in the longitudinal direction of the middle frame body 61b such that the upper and lower belt surfaces of the belt 48b become horizontal. Further, the belt 48b is wound around the idle pulleys 47b and 49b, which are held by the middle frame 6b to be rotationally movable. Furthermore, a part of the upper side of the belt 48b in the vicinity of the idle pulley 47b is connected to the middle frame body 61b by the middle frame connecting portion 62a, and a part of the lower side of the belt 48b in the vicinity of the idle pulley 49b is connected to the bed supporting unit 12a by the bed supporting unit connecting portion 13a. Thus, the belt 48b transmits the drive force transmitted to the middle frame body 61b from the belt 45 to the middle frame body 61a via the bed supporting unit connecting portion 13a and the middle frame connecting portion 62a, and causes the middle frame 6a to horizontally move in the longitudinal direction.

The belt 48a is located in the vicinity of the upper and lower surfaces in the longitudinal direction of the middle frame body 61a such that the upper and lower belt surfaces of the belt 48a become horizontal. Further, the belt 48a is wound around the idle pulleys 47a and 49a, which are located above the idle pulleys 47b and 49b, respectively, and are rotatably held by the middle frame 6a. Furthermore, a part of the upper side of the belt 48a in the vicinity of the idle pulley 47a is connected to the table-top body 51 by the table-top connecting portion 53a, and a part of the lower side of the belt 48a in the vicinity of the idle pulley 49a is connected to the middle frame body 61b by the middle frame connecting portion 62b. Thus, the belt 48a transmits the drive force transmitted to the middle frame body 61a to the table-top body 51 via the middle frame connecting portion 62b and the table-top connecting portion 53a, and causes the table-top 5a to horizontally move in the same direction as the middle frames 6a and 6b.

Thus, the horizontal moving mechanical unit 4a has a single simple structure, and is capable of horizontally moving the middle frames 6a and 6b of the horizontal moving unit 11a in the longitudinal direction and horizontally moving the table-top 5a in the same direction as the middle frames 6a and 6b.

With reference to FIGS. 24 to 35, the operation of the bed unit 10a will be then described.

When the object P to be subjected to the MRI imaging by the MRI imaging unit 100 is mounted on the table-top 5a of the bed unit 10a and thereafter a vertical position setting operation of the bed moving unit 1a is instructed by the operation unit 8, the system control unit 9 controls the vertical moving mechanical unit 7 to set the bed moving unit 1a at a position at which the upper surface of the bed supporting unit 12a of the bed moving unit 1a is aligned in height with the rails 125 provided in the opening part 124 of the gantry 120 of the MRI imaging unit 100.

Then, when a table-top position setting operation is instructed by the operation unit 8 to move the object P to the imaging position in the opening part 124, the system control unit 9 controls the horizontal moving mechanical unit 4a to move the horizontal moving unit 11a and set the table-top 5a at the imaging position in the opening part 124. Further, after completion of the MRI imaging, when a table-top home-positioning operation is instructed by the operation unit 8, the system control unit 9 controls the horizontal moving mechanical unit 4a to horizontally move the horizontal moving unit 11a to the home position of the bed supporting unit 12a.

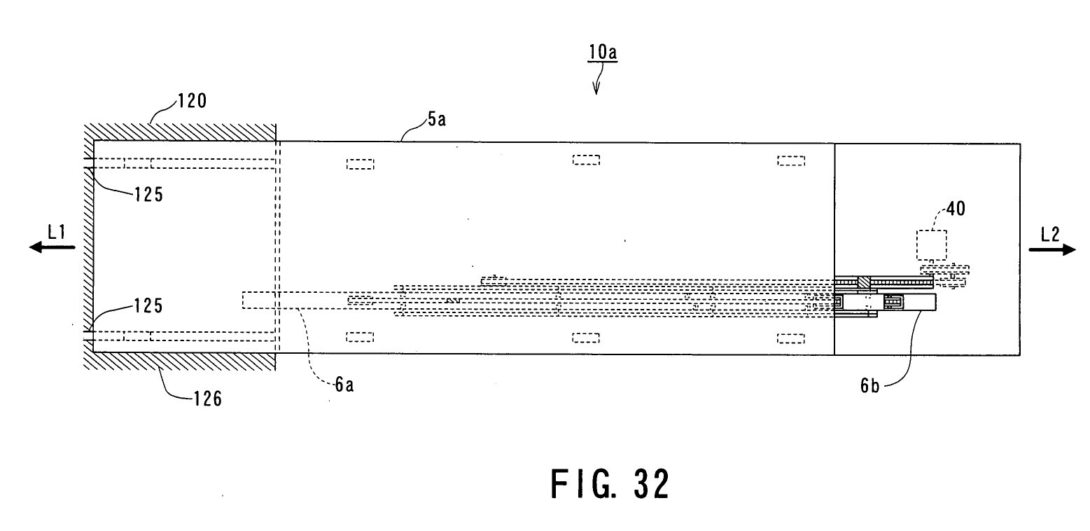

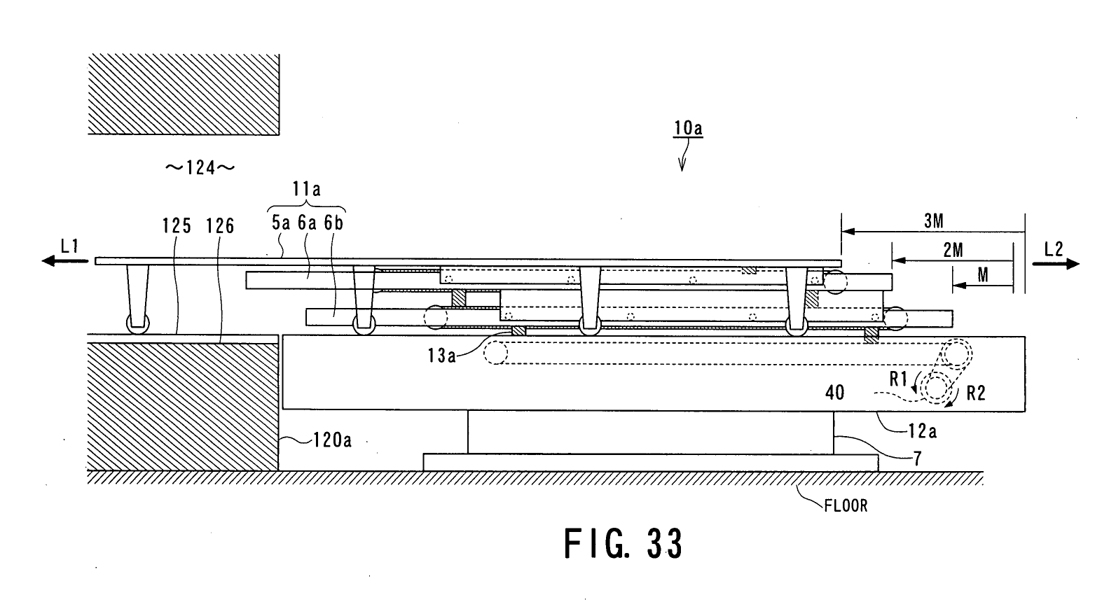

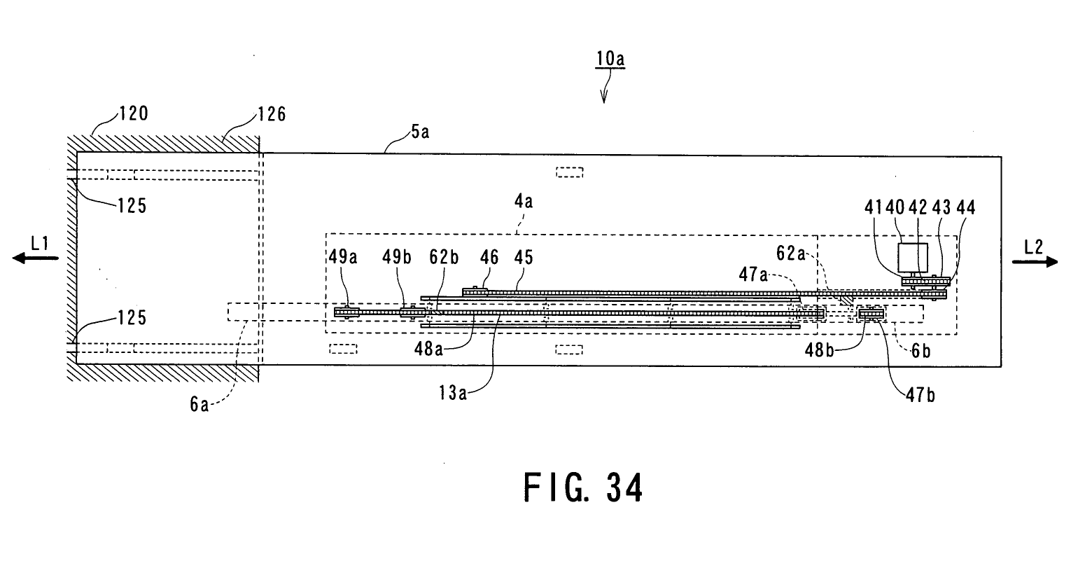

FIGS. 32 and 33 are diagrams illustrating the table-top 5a moving to the imaging position in the opening part 124. When an operation to set the table-top 5a at a position moved from the home position thereof in the direction of the arrow L1 by a distance 3M, for example, is instructed by the operation unit 8, the system control unit 9 instructs the horizontal moving mechanical unit 4a to set the position of the table-top 5a.

In accordance with the instruction sent by the system control unit 9, the horizontal moving mechanical unit 4a causes the motor 40 to rotate in the direction of the arrow R1. Thereby, the middle frame 6b, the middle frame 6a, and the table-top 5a of the horizontal moving unit 11a are horizontally moved from the home positions thereof in the direction of L1. Then, the middle frame 6b, the middle frame 6a, and the table-top 5a are set at respective positions apart from the home positions thereof by a distance M, a distance 2M, and a distance 3M, respectively.

Further, when the table-top home-positioning operation is instructed by the operation unit 8, the horizontal moving mechanical unit 4a causes the motor 40 to rotate in the direction of the arrow R2. Thereby, the horizontal moving unit 11a is horizontally moved in the direction of L2 and set at the original home position thereof.

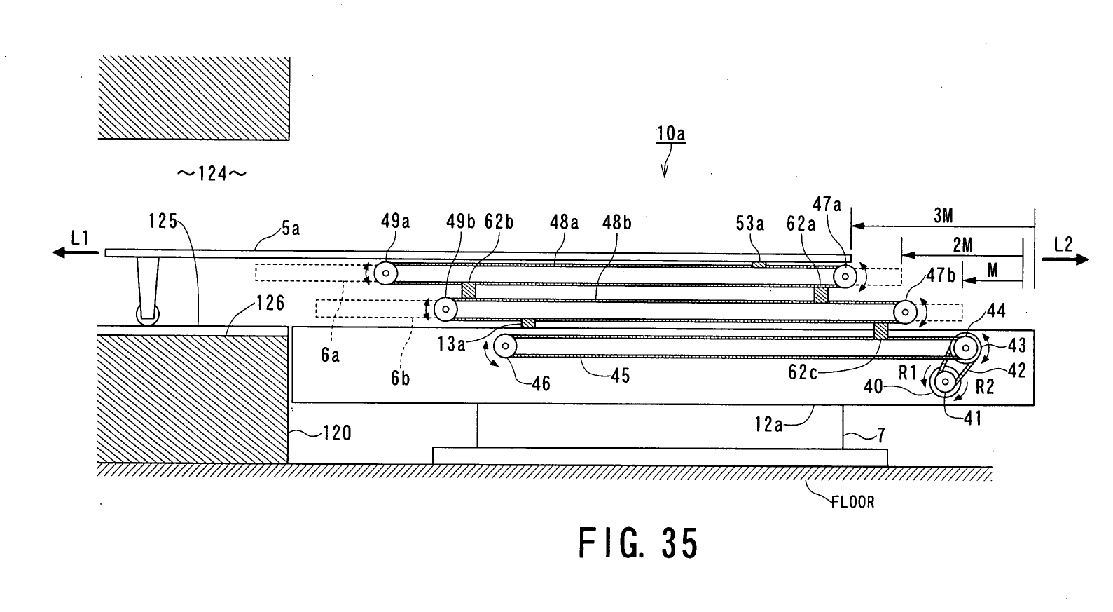

FIGS. 34 and 35 are diagrams for explaining the operation of the horizontal moving mechanical unit 4a in moving the horizontal moving unit 11a in the direction of L1. FIG. 34 is a view of an upper part of the bed unit 10a as viewed from the above, and FIG. 35 is a view of a lateral side of the bed unit 10a as viewed from the left side.

In the mechanism of the horizontal moving mechanical unit 4a held by the bed supporting unit 12a, as the motor 40 is rotated in the direction of the arrow R1, the drive force for rotating the input pulley 43 and the output pulley 44 in the direction of R1 is transmitted via the drive pulley 41 and the belt 42. Then, the drive force of the output pulley 44 is transmitted as the drive force for moving the upper side of the belt 45 in the direction of L1.

In the mechanism of the horizontal moving mechanical unit 4a held by the middle frame 6b, the drive force is transmitted by the drive force of the belt 45 to the middle frame body 61b connected to the belt 45 via the middle frame connecting portion 62c as the drive force for moving the middle frame 6b in the direction of L1. Due to the drive force of the middle frame body 61b, the drive force in the direction of L1 is transmitted to the idle pulleys 47b and 49b, which are held by the middle frame body 61b.

Further, due to the drive force of the idle pulleys 47b and 49b, the drive force in the direction of L1 is transmitted to the belt 48b wound around the idle pulleys 47b and 49b. Since the belt 48b is connected to the bed supporting unit 12a via the bed supporting unit connecting portion 13a, the drive force is transmitted as the drive force for rotating the idle pulleys 47b and 49b in the direction of R1 and moving the upper side of the belt 48b in the direction of L1.

In the mechanism of the horizontal moving mechanical unit 4a located by the middle frame 6a, the drive force is transmitted by the drive force of the belt 48b to the middle frame body 61a connected to the belt 48b via the middle frame connecting portion 62a as the drive force for moving the middle frame 6a in the direction of L1. Due to the drive force of the middle frame body 61a, the drive force in the direction of L1 is transmitted to the idle pulleys 47a and 49a, which are held by the middle frame body 61a.

Further, due to the drive force of the idle pulleys 47a and 49a, the drive force in the direction of L1 is transmitted to the belt 48a wound around the idle pulleys 47a and 49a. Since the belt 48a is connected to the middle frame body 61b via the middle frame connecting portion 62b, the drive force is transmitted as the drive force for rotating the idle pulleys 47a and 49a in the direction of R1 and moving the upper side of the belt 48a in the direction of L1.

Then, due to the drive force of the belt 48a, the drive force for moving the table-top 5a in the direction of L1 is transmitted to the table-top body 51 via the table-top connecting portion 53a. Thereby, the table-top 5a can move in the direction of L1.

The moving distances of the middle frames 6a and 6b and the table-top 5a will be then described. When the upper side of the belt 45 is moved in the direction of L1 by the distance M in accordance with a predetermined number of rotations of the motor 40 in the direction of R1, the middle frame 6b is also moved via the middle frame connecting portion 62c in the direction of L1 by the distance M. Then, as the middle frame 6b is moved, the upper side of the belt 48b is moved in the direction of L1 by the distance M, and the middle frame 6a is also moved via the middle frame connecting portion 62a in the direction of L1 by the distance M. As the middle frame 6a is moved, the upper side of the belt 48a is moved in the direction of L1 by the distance M, and the table-top 5a is moved via the table-top connecting portion 53a in the direction of L1 by the distance M.

That is, the middle frame 6a moves above the middle frame 6b in the direction of L1 by the distance M while the middle frame 6b moves above the bed supporting unit 12a in the direction of L1 by the distance M. Further, the table-top 5a moves above the middle frame 6a by the distance M while the middle frame 6a moves above the middle frame 6b in the direction of L1 by the distance M. Accordingly, the table-top 5a moves with respect to the bed supporting unit 12a by the distance 3M, and is set at a position more apart from the bed supporting unit 12a than the middle frames 6b and 6a are.

The middle frame 6b can move within a range in which the middle frame connecting portion 62c moves from the home position thereof to reach the vicinity of the idle pulley 46. Further, the middle frame 6a can move within a range in which the middle frame connecting portion 62a moves from the home position thereof to reach the vicinity of the idle pulley 49b. Furthermore, the table-top 5a can move within a range in which the table-top connecting portion 53a moves from the home position thereof to reach the vicinity of the idle pulley 49a.

Therefore, when the distance Lmax indicated in FIG. 28 represents the distance between the middle frame connecting portion 62c in the home position thereof and the vicinity of the idle pulley 46, the distance between the middle frame connecting portion 62a in the home position thereof and the vicinity of the idle pulley 49b, and the distance between the table-top connecting portion 53a in the home position thereof and the vicinity of the idle pulley 49a, respectively, the table-top 5a can be set at the position in the opening part 124 apart from the bed supporting unit 12a by the distance 3Lmax.

According to the above-described second embodiment of the present invention, the two middle frames 6a and 6b are provided between the table-top 5a and the bed supporting unit 12a, and the bed supporting unit 12a and the middle frames 6a and 6b are located with the horizontal moving mechanical unit 4a of a single simple structure. Accordingly, the middle frame 6b can be moved together with the middle frame 6a and the table-top 5a. Further, due to the movement of the middle frame 6b, the middle frame 6a can be moved together with the table-top 5a in the same direction as the middle frame 6b. Furthermore, due to the movement of the middle frame 6a, the table-top 5a can be moved in the same direction as the middle frame 6a and set at a position more apart from the bed supporting unit 12a than the middle frames 6a and 6b are.

Accordingly, it is possible to prevent an increase in length in the longitudinal direction of the table-top 5a, and thus to prevent an increase in size of the bed unit 10a.

The present invention is not limited to the above-described embodiments. Thus, it is possible to provide three or more middle frames vertically located between the table-top and the bed supporting unit, and to located the horizontal moving mechanical unit of a single simple structure to the bed supporting unit and the three or more middle frames. With this configuration, the table-top can be set at a position further apart from the bed supporting unit than in the above-described case including the two middle frames 6a and 6b.

What is claimed is:

1. A bed apparatus comprising:
a table-top movable at least in a longitudinal direction;
a bed supporting unit located below the table-top;
an intermediate unit located at a position between the table-top and the bed supporting unit and not overlapping with a center in a width direction of the table-top, and movable in the same direction as the table-top; and
a changing unit configured to change a relative positional relationship of the table-top and the intermediate unit while the intermediate unit moves with respect to the bed supporting unit.

2. A bed apparatus according to claim 1, further comprising a first moving mechanism held by the bed supporting unit, a drive mechanism, held by the bed supporting unit, configured to operate the first moving mechanism, and a second moving mechanism, held by the intermediate unit connected to the first moving mechanism, configured to connect to the table-top, wherein the table-top is moved in the same direction as the intermediate unit because the drive mechanism drives to operate the first moving mechanism, the intermediate unit is moved, and the second moving mechanism is operated.

3. A bed apparatus according to claim 1, wherein when the intermediate unit moves a predetermined distance, the table-top is moved a distance twice as long as the predetermined distance.

4. A bed apparatus according to claim 2, further comprising a first belt, held by the first moving mechanism, configured to transmit a drive force supplied by the drive mechanism to the second moving mechanism, a first pulley, held by the bed supporting unit, configured to rotate because the first belt is wound, and a second pulley, held by the bed supporting unit, configured to rotate because the first belt is wound.

5. A bed apparatus according to claim 4, further comprising a second belt, held by the second moving mechanism, configured to connect a part of upside of the second belt with the table-top, and configured to transmit a drive force supplied by the first belt, a third pulley, held by the intermediate unit, configured to rotate because the second belt wind, and a fourth pulley, held by the intermediate unit, configured to rotate because the second belt wind.

6. A bed apparatus according to claim 1, wherein the table-top is configured to have a longer length in the longitudinal direction than the length in the longitudinal direction of the intermediate unit.

7. A bed apparatus according to claim 1, wherein the intermediate unit is held by the bed supporting unit to be capable of moving in the longitudinal direction.

8. A bed apparatus according to claim 1, further comprising a transmitting unit located at a position between the table-top and the bed supporting unit and overlapping with a center in a width direction of the table-top, wherein the transmitting unit configured to transmit at least one of a received signal sent from an imaging unit and a control signal to be sent to the imaging unit.

9. A bed apparatus comprising:
a table-top movable at least in a longitudinal direction;
a bed supporting unit located below the table-top;
a first intermediate unit located at a position between the table-top and the bed supporting unit and not overlapping with a center in a width direction of the table-top, and movable in the same direction as the table-top;
a second intermediate unit located at a position between the table-top and the first intermediate unit and not overlapping with the center in the width direction of the table-top, and movable in the same direction as the table-top; and
a changing unit configured to change a relative positional relationship of the table-top, the first intermediate unit and the second intermediate unit while the first intermediate unit moves with respect to the bed supporting unit.

10. A bed apparatus comprising:
a table-top movable at least in a longitudinal direction;
a bed supporting unit located below the table-top;
a plurality of intermediate units located at a position between the table-top and the bed supporting unit and not overlapping with a center in a width direction of the table-top, and movable in the same direction as the table-top; and
a changing unit configured to change a relative positional relationship of the table-top and the plurality of intermediate units while one of the plurality of intermediate units moves with respect to the bed supporting unit.

11. An MRI apparatus comprising:
a table-top movable at least in a longitudinal direction;
a bed supporting unit located below the table-top;
an intermediate unit located at a position between the table-top and the bed supporting unit and not overlapping with a center in a width direction of the table-top, and movable in the same direction as the table-top; and
a changing unit configured to change a relative positional relationship of the table-top and the intermediate unit while the intermediate unit moves with respect to the bed supporting unit.

12. An MRI apparatus according to claim 11, further comprising a first moving mechanism held by the bed supporting unit, a drive mechanism, held by the bed supporting unit, configured to operate the first moving mechanism, and a second moving mechanism, held by the intermediate unit connected to the first moving mechanism, configured to connect to the table-top, wherein the table-top is moved in the same direction as the intermediate unit because the drive mechanism drives to operate the first moving mechanism, the intermediate unit is moved, and the second moving mechanism is operated.

13. An MRI apparatus according to claim 11, wherein when the intermediate unit moves a predetermined distance, the table-top is moved a distance twice as long as the predetermined distance.

14. An MRI apparatus according to claim 12, further comprising a first belt, held by the first moving mechanism, configured to transmit a drive force supplied by the drive mechanism to the second moving mechanism, a first pulley, held by the bed supporting unit, configured to rotate because the first belt is wound, and a second pulley, held by the bed supporting unit, configured to rotate because the first belt is wound.

15. An MRI apparatus according to claim 14, further comprising a second belt, held by the second moving mechanism, configured to connect a part of upside of the second belt with the table-top, and configured to transmit a drive force supplied by the first belt, a third pulley, held by the intermediate unit, configured to rotate because the second belt wind, and a fourth pulley, held by the intermediate unit, configured to rotate because the second belt wind.

16. An MRI apparatus according to claim 11, wherein the table-top is configured to have a longer length in the longitudinal direction than the length in the longitudinal direction of the intermediate unit.

17. An MRI apparatus according to claim 11, wherein the intermediate unit is held by the bed supporting unit to be capable of moving in the longitudinal direction.

18. An MRI apparatus according to claim 11, further comprising a transmitting unit located at a position between the table-top and the bed supporting unit and overlapping with a center in a width direction of the table-top, wherein the transmitting unit configured to transmit at least one of a received signal sent from an MRI imaging unit and a control signal to be sent to the imaging unit.

19. An MRI apparatus according to claim 18, wherein a the transmitting unit transmits at least one of the received signal sent from a plurality of surface coils and the control signal to be sent to the plurality of surface coils.

20. An MRI apparatus comprising:
a table-top movable at least in a longitudinal direction;
a bed supporting unit located below the table-top;
a first intermediate unit located at a position between the table-top and the bed supporting unit and not overlapping with a center in a width direction of the table-top, and movable in the same direction as the table-top;
a second intermediate unit located at a position between the table-top and the first intermediate unit and not overlapping with the center in the width direction of the table-top, and movable in the same direction as the table-top; and
a changing unit configured to change a relative positional relationship of the table-top, the first intermediate unit and the second intermediate unit while the first intermediate unit moves with respect to the bed supporting unit.

21. An MRI apparatus comprising:
a table-top movable at least in a longitudinal direction;
a bed supporting unit located below the table-top;
a plurality of intermediate units located at a position between the table-top and the bed supporting unit and not overlapping with a center in a width direction of the table-top, and movable in the same direction as the table-top; and
a changing unit configured to change a relative positional relationship of the table-top and the plurality of intermediate units while one of the plurality of intermediate units moves with respect to the bed supporting unit.
